(19) United States
(12) Patent Application Publication
(10) Pub. No.: US 2017/0011318 A1
(43) Pub. Date: Jan. 12, 2017

(54) AUTOMATED MONITORING AND SERVICE PROVIDER RECOMMENDATION PLATFORM FOR HVAC EQUIPMENT

(71) Applicant: Johnson Controls Technology Company, Holland, MI (US)

(72) Inventors: Simone Vigano, Milwaukee, WI (US); Sudhi Sinha, Milwaukee, WI (US); Youngchoon Park, Brookfield, WI (US); Marc Perrone, Shorewood, WI (US); Ada Ma, Milwaukee, WI (US); Justin Ploegert, Milwaukee, WI (US); Kyle Gustafson, Milwaukee, WI (US); Erik Paulson, Milwaukee, WI (US)

(73) Assignee: Johnson Controls Technology Company, Holland, MI (US)

(21) Appl. No.: 14/990,756

(22) Filed: Jan. 7, 2016

Related U.S. Application Data
(60) Provisional application No. 62/190,614, filed on Jul. 9, 2015.

(51) Int. Cl. G06Q 10/06; G06Q 50/08; G06N 5/04

(52) U.S. Cl. CPC G06Q 10/06313; G06N 5/04; G06Q 50/08

(57) ABSTRACT

A contractor recommendation system includes one or more databases storing contractor attributes for a plurality of contractors and attribute weights indicating a relative importance of each of the contractor attributes. The system uses the contractor attributes and the attribute weights to select one or more recommended contractors for a building owner and generates a contractor recommendation comprising an indication of the one or more recommended contractors. The system provides the contractor recommendation to the building owner and receives a contractor selection from the building owner. The system uses the contractor selection as a feedback to determine an importance of each of the contractor attributes to the building owner and automatically updates the stored attribute weights based on the determined importance.

### CROSS-REFERENCE TO RELATED PATENT APPLICATION

This application claims the benefit of and priority to U.S. Provisional Patent Application No. 62/190,614 filed Jul. 9, 2015, the entirety of which is incorporated by reference herein.

### BACKGROUND

Traditional customer relationships in the HVAC industry often do not allow for a continuing relationship between and equipment manufacturer and a building owner or end user of the HVAC equipment. For example, the equipment manufacturer typically provides HVAC equipment to a distributor. The distributor receives purchase orders from a contractor (e.g., a reseller or service provider) and provides the HVAC equipment to the contractor. The contractor then installs the HVAC equipment in the building of an owner or end user. The manufacturer interacts only with the distributor and has no contact with the building owner or end user of the HVAC equipment. Once the HVAC equipment is installed, the owner or end user interacts only with the contractor if the HVAC equipment requires service or replacement.

### SUMMARY

One implementation of the present disclosure is a contractor recommendation system. The system includes one or more databases storing contractor attributes for a plurality of contractors and attribute weights indicating a relative importance of each of the contractor attributes. The system further includes a contractor recommender that uses the contractor attributes and the attribute weights to select one or more recommended contractors for a building owner and generates a contractor recommendation comprising an indication of the one or more recommended contractors. The system further includes a communications interface that provides the contractor recommendation to the building owner and receives a contractor selection from the building owner. The system further includes a weight updater that uses the contractor selection as a feedback to determine an importance of each of the contractor attributes to the building owner and automatically updates the stored attribute weights based on the determined importance.

In some embodiments, the one or more databases store building owner attributes for a plurality of building owners. The contractor recommender may use the building owner attributes in conjunction with the contractor attributes and the attribute weights to generate the contractor recommendation. In some embodiments, the system includes an owner profiler/clusterer that uses the building owner attributes to generate a profile for each of the plurality of building owners and group the building owners into clusters of similar building owners.

In some embodiments, the one or more databases store a separate set of attribute weights for each building owner or cluster of building owners. Each set of attribute weights may indicate a relative importance of each of the contractor attributes to a specific building owner or cluster of building owners.

In some embodiments, the system includes a distance calculator that determines a distance between a contractor selected by the building owner and each of the recommended contractors. The distance may be a similarity metric based on the contractor attributes of the selected and recommended contractors. In some embodiments, the distance calculator determines, for each of the contractor attributes, an attribute-specific distance between the selected contractor and each of the recommended contractors, wherein each attribute-specific distance is a similarity metric for a particular contractor attribute. In some embodiments, the distance calculator receives an indication of multiple contractors selected by the building owner or cluster of building owners and determines, for each of the contractor attributes, an attribute-specific distance between values of the contractor attribute for each of the selected contractors.

In some embodiments, the system includes a deviation calculator that uses the contractor selection to calculate an attribute-specific deviation for each of the contractor attributes. The deviation may indicate which of the contractor attributes are most important to the building owner. In some embodiments, the deviation calculator receives an indication of multiple contractors selected by the building owner or cluster of building owners, identifies, for each of the contractor attributes, a value of the contractor attribute for each of the selected contractors; and calculates, for each of the contractor attributes, the attribute-specific deviation among the identified values of the contractor attribute. In some embodiments, the weight updater uses the attribute-specific deviations for each of the contractor attributes to determine the importance of each of the contractor attributes to the building owner.

Another implementation of the present disclosure is a monitoring and service provider recommendation (MSPR) platform. The MSPR platform includes a contractor recommender that automatically selects one or more recommended contractors for a building owner and a lead generator that generates leads for each of the recommended contractor. The leads indicate an opportunity to service building equipment associated with the building owner. The MSPR platform includes a bid selector that solicits bids for servicing the building equipment from the recommended contractors and provides the bids to the building owner. The building owner selects a recommended contractor in response to receiving the bids. The MSPR platform includes a winning contractor notifier that notifies the selected contractor of winning the bid and provides the selected contractor with customer information relating to the building owner or the building equipment associated with the building owner.

In some embodiments, the MSPR platform includes a fault detector that receives data from the building equipment and detects a fault in the building equipment based on the data received from the building equipment. The MSPR platform may include an alert generator that generates an alert for the building owner in response to detecting the fault.

In some embodiments, the MSPR platform includes an interface generator that generates a user interface for the building owner to interact with the MSPR platform. The user interface may include an indication of the detected fault and an interface option for allowing the building owner to request a quote for servicing the building equipment. In some embodiments, the contractor recommender selects the recommended contractors for the building owner in response to receiving a request for a quote from the building owner via the user interface.

Another implementation of the present disclosure is a method for providing contractor recommendations to a building owner. The method includes storing, in one or more databases, contractor attributes for a plurality of contractors and attribute weights indicating a relative importance of each of the contractor attributes. The method includes using the contractor attributes and the attribute weights to automatically select, by a processing circuit of a contractor recommendation system, one or more recommended contractors for a building owner. The method includes generating, by the processing circuit, a contractor recommendation including an indication of the one or more recommended contractors. The method includes providing the contractor recommendation to the building owner and receiving a contractor selection from the building owner via a communications interface of the contractor recommendation system. The method includes using the contractor selection as a feedback to determine, by the processing circuit, an importance of each of the contractor attributes to the building owner. The method includes automatically updating, by the processing circuit, the stored attribute weights based on the determined importance.

In some embodiments, the one or more databases store a separate set of attribute weights for each building owner or cluster of building owners. Each set of attribute weights may indicate a relative importance of each of the contractor attributes to a specific building owner or cluster of building owners.

In some embodiments, the method includes determining a distance between a contractor selected by the building owner and each of the recommended contractors. The distance may be a similarity metric based on the contractor attributes of the selected and recommended contractors.

In some embodiments, the method includes using the contractor selection to calculate an attribute-specific deviation for each of the contractor attributes. The deviation may indicate which of the contractor attributes are most important to the building owner. In some embodiments, calculating the attribute-specific deviation includes receiving an indication of multiple contractors selected by the building owner or cluster of building owners, identifying, for each of the contractor attributes, a value of the contractor attribute for each of the selected contractors, and calculating, for each of the contractor attributes, the attribute-specific deviation among the identified values of the contractor attribute. In some embodiments, the method includes using the attribute-specific deviations for each of the contractor attributes to determine the importance of each of the contractor attributes to the building owner.

### BRIEF DESCRIPTION OF THE DRAWINGS

FIG. 1 is a drawing of a building equipped with a HVAC system, according to an exemplary embodiment.

FIG. 2 is a block diagram of a waterside system which may be used as part of the HVAC system of FIG. 1, according to an exemplary embodiment.

FIG. 3 is a block diagram of an airside system which may be used as part of the HVAC system of FIG. 1, according to an exemplary embodiment.

FIG. 4 is a block diagram of a system of smart connected HVAC equipment and a monitoring and service provider recommendation (MSPR) platform that leverages data from the smart connected HVAC equipment to provide service provider recommendations, according to an exemplary embodiment.

FIG. 5 is a block diagram illustrating the MSPR platform communicating directly with people, smart connected devices, buildings, and businesses, according to an exemplary embodiment.

FIG. 6 is a block diagram illustrating a smart connected device communicating with a building infrastructure, a building owner, a MSPR platform, an equipment manufacturer, a facility manager, a contractor, and other connected devices/controllers, according to an exemplary embodiment.

FIG. 7 is a flowchart illustrating multiple stages for implementing the MSPR platform including connected equipment, connected buildings, and connected business, according to an exemplary embodiment.

FIG. 8 is a block diagram illustrating a traditional customer relationship in the HVAC industry, according to an exemplary embodiment.

FIG. 9 is a block diagram illustrating a manufacturer-centric customer relationship made possible by the MSPR platform, according to an exemplary embodiment.

FIG. 10 is a block diagram illustrating a process for providing temporary access credentials to a contractor for accessing a smart connected device to obtain data from the device and perform remote diagnostics, according to an exemplary embodiment.

FIG. 11 is a block diagram illustrating the components of an ecosystem in which the MSPR platform may be implemented, according to an exemplary embodiment.

FIG. 12 is a flow diagram illustrating a process for providing automated service provider recommendations for smart connected HVAC equipment, according to an exemplary embodiment.

FIG. 13 is a block diagram illustrating the MSPR platform in greater detail, according to an exemplary embodiment.

FIG. 14 is an example of a web interface which may be provided to a building owner by the MSPR platform for monitoring the building owner's HVAC equipment, according to an exemplary embodiment.

FIG. 15 is an example of an interface which may be provided to the building owner by the MSPR platform for viewing the health status of the HVAC equipment, according to an exemplary embodiment.

FIG. 16 is an example of an interface which may be provided to the building owner by the MSPR platform when a problem is detected with the HVAC equipment, according to an exemplary embodiment.

FIG. 17 is an example of an email message which may be provided to the building owner by the MSPR platform when a problem is detected with the HVAC equipment, according to an exemplary embodiment.

FIG. 18 is an example of an interface which may be provided to a contractor by the MSPR platform for viewing available leads, according to an exemplary embodiment.

FIG. 19 is an example of an interface which may be provided to the contractor by the MSPR platform for placing bids on available leads, according to an exemplary embodiment.

FIG. 20 is an example of an interface which may be provided to the contractor by the MSPR platform for viewing the status of the bids proposed by the contractor, according to an exemplary embodiment.

FIG. 21 is an example of a user interface which may be provided to the sales representative by the MSPR platform for monitoring and viewing service or sales opportunities for smart connected HVAC equipment, according to an exemplary embodiment.

FIG. 22 is an example of a user interface which may be provided to the sales representative by the MSPR platform for viewing summary information associated with a selected opportunity, according to an exemplary embodiment.

FIG. 23 is an example of a user interface which may be provided to the sales representative by the MSPR platform for viewing details of the HVAC equipment, according to an exemplary embodiment.

FIG. 24 is an example of a user interface which may be provided to the sales representative by the MSPR platform for viewing a service history for the HVAC equipment, according to an exemplary embodiment.

FIG. 25 is an example of a user interface which may be provided to the sales representative by the MSPR platform for viewing replacement opportunities for the HVAC equipment, according to an exemplary embodiment.

FIG. 26 is an example of a user interface which may be provided to the sales representative by the MSPR platform for viewing the system health of the HVAC equipment, according to an exemplary embodiment.

FIG. 27 is a block diagram illustrating the motivation for subjectivity modeling in automated service provider recommendations, according to an exemplary embodiment.

FIG. 28 is block diagram of a contractor recommendation system which may be implemented as a component of the MSPR platform, according to an exemplary embodiment.

FIG. 29 is a graph illustrating attribute-specific distances for several contractor attributes, according to an exemplary embodiment.

FIG. 30 is a flowchart of a process for using subjectivity modeling to provide contractor recommendations, according to an exemplary embodiment.

### DETAILED DESCRIPTION

### Overview

An automated monitoring and service provider recommendation (MSPR) platform is used to facilitate a manufacturer-centric customer relationship. In the manufacturer-centric customer relationship, the manufacturer uses MSPR platform 402 to interact directly with the distributor, the contractor, and the building owner or end user. Smart connected HVAC equipment within the building of the owner or end user communicates with MSPR platform 402, which may be owned or operated by the manufacturer. For example, smart connected HVAC equipment 408 may transmit its current status, analytics results, fault detections, measurements, its identity, an equipment model that represents smart connected HVAC equipment 408, a software version, a hardware version, and/or other information to MSPR platform 402. MSPR platform 402 may use the data from smart connected HVAC equipment 408 to automatically detect and diagnose faults and to determine appropriate replacement or repair actions for the HVAC equipment. MSPR platform 402 may send alerts and a list of local contractors (e.g., service providers) to the building owner. The building owner may then select one of the contractors to service the HVAC equipment.

The manufacturer-centric customer relationship represents a fundamental shift in managing customer relationships in the HVAC industry. This relationship change may result in weaker dependency on the distributors and contractors. The manufacturer now has the opportunity to capture more profits from the overall value chain. Furthermore, the manufacturer can use the data received from smart connected HVAC equipment 408 to learn how its products and features are being accessed and utilized.

A detected fault represents repair or replacement opportunity for smart connected HVAC equipment 408, which becomes revenue for a contractor and a part sale opportunity for a distributor. MSPR platform 402 may present these opportunities to both the contractor and the distributor to capture business in almost real-time. Given an informed fault (e.g., a fault accompanied by diagnostic information), the contractor may prepare a service cost estimate based on service part availability and diagnostic results. The contractor may submit a bid to MSPR platform 402, which provides the bid, along with bids from other contractors, to the building owner. The building owner can select a contractor based on the bid information and service proposals. Once a contractor is selected, MSPR platform 402 may inform the selected contractor that it has won the service contract.

Advantageously, the systems and methods described herein use subjectivity modeling to capture a building owner's subjective preferences based on the actual decisions (i.e., contractor selections) made by the building owner. This allows the systems and methods of the present invention to automatically determine which contractor attributes are most important to a building owner (e.g., as evidenced by the building owner's contractor selections) without requiring the building owner to explicitly rank the importance of each contractor attribute. Additional features and advantages of the present invention are described in greater detail below.

Building with HVAC Equipment

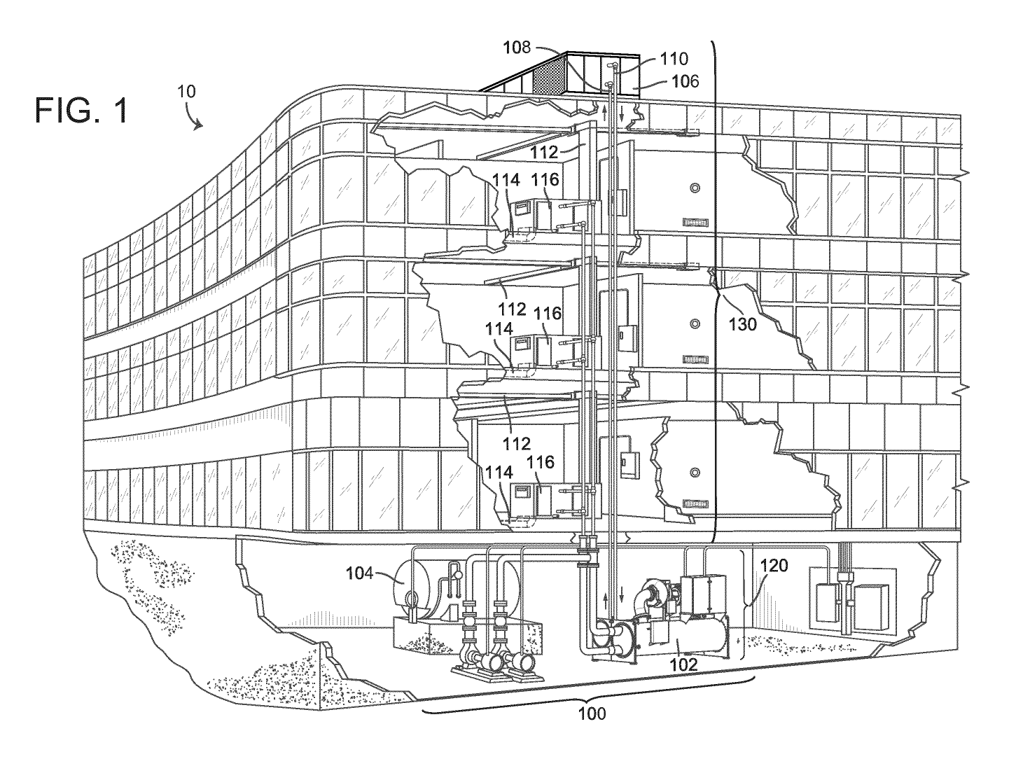

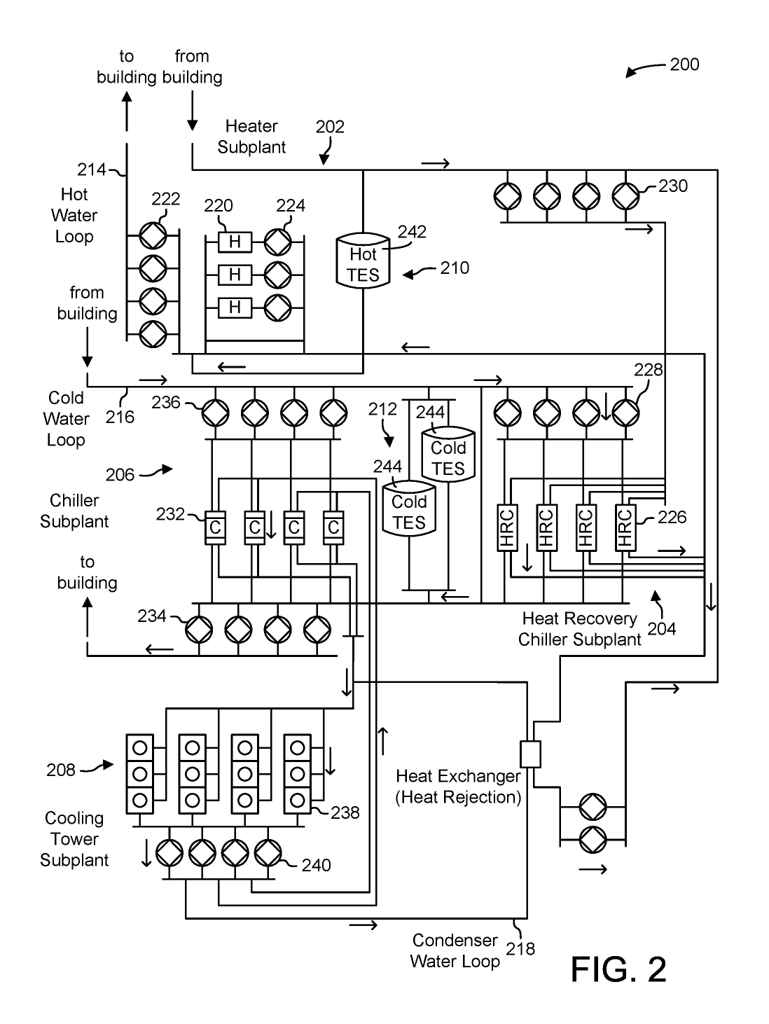

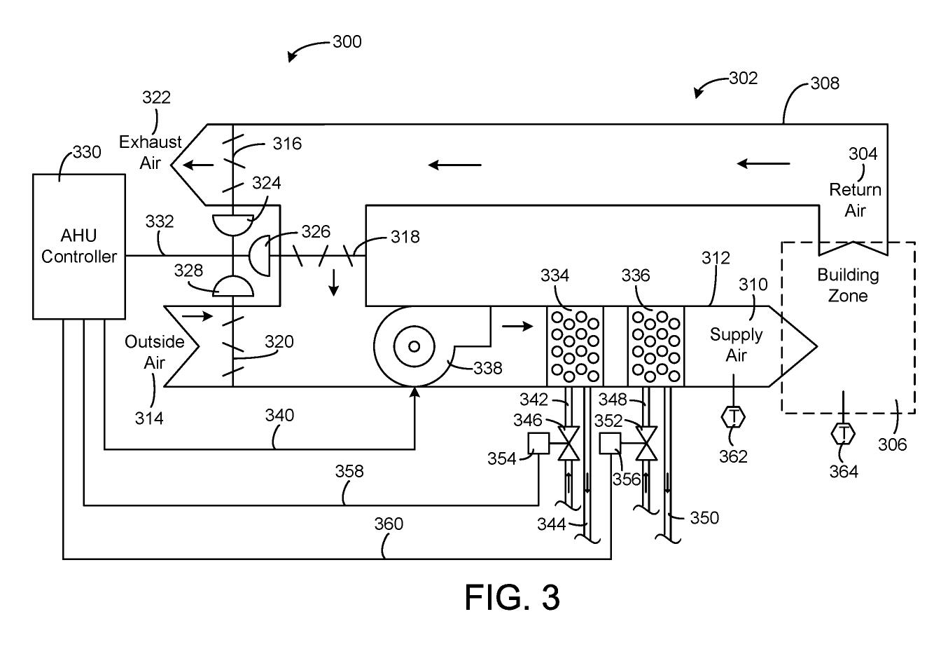

Referring now to FIG. 1, a perspective view of a building 10 is shown. Building 10 includes a HVAC system 100. HVAC system 100 may include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 may provide a heated or chilled fluid to an air handling unit of airside system 130. Airside system 130 may use the heated or chilled fluid to heat or cool an airflow provided to building 10. An exemplary waterside system and airside system which may be used in HVAC system 100 are described in greater detail with reference to FIGS. 2-3.

HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 may be located in or around building 10 (as shown in FIG. 1) or at an offsite location such as a central plant (e.g., a chiller plant, a steam plant, a heat plant, etc.). The working fluid may be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 may be transported to AHU 106 via piping 108.

AHU 106 may place the working fluid in a heat exchange relationship with an airflow passing through AHU 106 (e.g., via one or more stages of cooling coils and/or heating coils). The airflow may be, for example, outside air, return air from within building 10, or a combination of both. AHU 106 may transfer heat between the airflow and the working fluid to provide heating or cooling for the airflow. For example, AHU 106 may include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 may include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 may include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve setpoint conditions for the building zone.

Referring now to FIG. 2, a block diagram of a waterside system 200 is shown, according to an exemplary embodiment. In various embodiments, waterside system 200 may supplement or replace waterside system 120 in HVAC system 100 or may be implemented separate from HVAC system 100. When implemented in HVAC system 100, waterside system 200 may include a subset of the HVAC devices in HVAC system 100 (e.g., boiler 104, chiller 102, pumps, valves, etc.) and may operate to supply a heated or chilled fluid to AHU 106. The HVAC devices of waterside system 200 may be located within building 10 (e.g., as components of waterside system 120) or at an offsite location such as a central plant.

In FIG. 2, waterside system 200 is shown as a central plant having a plurality of subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve the thermal energy loads (e.g., hot water, cold water, heating, cooling, etc.) of a building or campus. For example, heater subplant 202 may be configured to heat water in a hot water loop 214 that circulates the hot water between heater subplant 202 and building 10. Chiller subplant 206 may be configured to chill water in a cold water loop 216 that circulates the cold water between chiller subplant 206 building 10. Heat recovery chiller subplant 204 may be configured to transfer heat from cold water loop 216 to hot water loop 214 to provide additional heating for the hot water and additional cooling for the cold water. Condenser water loop 218 may absorb heat from the cold water in chiller subplant 206 and reject the absorbed heat in cooling tower subplant 208 or transfer the absorbed heat to hot water loop 214. Hot TES subplant 210 and cold TES subplant 212 may store hot and cold thermal energy, respectively, for subsequent use.

Hot water loop 214 and cold water loop 216 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air may be delivered to individual zones of building 10 to serve the thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) may be used in place of or in addition to water to serve the thermal energy loads. In other embodiments, subplants 202-212 may provide heating and/or cooling directly to the building or campus without requiring an intermediate heat transfer fluid. These and other variations to waterside system 200 are within the teachings of the present invention.

Each of subplants 202-212 may include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 may also include one or more pumps or valves configured to control the flow rate of the hot water into or out of hot TES tank 242. Cold TES subplant 212 is shown to include cold TES tanks 244 configured to store the cold water for later use. Cold TES subplant 212 may also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves may be integrated with the pumps or positioned upstream or downstream of the pumps to control the fluid flows in waterside system 200. In various embodiments, waterside system 200 may include more, fewer, or different types of devices and/or subplants based on the particular configuration of waterside system 200 and the types of loads served by waterside system 200.

Referring now to FIG. 3, a block diagram of an airside system 300 is shown, according to an exemplary embodiment. In various embodiments, airside system 300 may supplement or replace airside system 130 in HVAC system 100 or may be implemented separate from HVAC system 100. When implemented in HVAC system 100, airside system 300 may include a subset of the HVAC devices in HVAC system 100 (e.g., AHU 106, VAV units 116, ducts 112-114, fans, dampers, etc.) and may be located in or around building 10. Airside system 300 may operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 may receive return air 304 from building zone 306 via return air duct 308 and may deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 may be configured to operate exhaust air damper 316, mixing damper 318, and outside air damper 320 to control an amount of outside air 314 and return air 304 that combine to form supply air 310. Any return air 304 that does not pass through mixing damper 318 may be exhausted from AHU 302 through exhaust damper 316 as exhaust air 322.

Each of dampers 316-320 may be operated by an actuator. For example, exhaust air damper 316 may be operated by actuator 324, mixing damper 318 may be operated by actuator 326, and outside air damper 320 may be operated by actuator 328. Actuators 324-328 may communicate with an AHU controller 330 via a communications link 332. Actuators 324-328 may receive control signals from AHU controller 330 and may provide feedback signals to AHU controller 330. Feedback signals may include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that may be collected, stored, or used by actuators 324-328. AHU controller 330 may be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 may be configured to force supply air 310 through cooling coil 334 and/or heating coil 336 and provide supply air 310 to building zone 306. AHU controller 330 may communicate with fan 338 via communications link 340 to control a flow rate of supply air 310. In some embodiments, AHU controller 330 controls an amount of heating or cooling applied to supply air 310 by modulating a speed of fan 338.

Cooling coil 334 may receive a chilled fluid from waterside system 200 (e.g., from cold water loop 216) via piping 342 and may return the chilled fluid to waterside system 200 via piping 344. Valve 346 may be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330) to modulate an amount of cooling applied to supply air 310.

Heating coil 336 may receive a heated fluid from waterside system 200 (e.g., from hot water loop 214) via piping 348 and may return the heated fluid to waterside system 200 via piping 350. Valve 352 may be positioned along piping 348 or piping 350 to control a flow rate of the heated fluid through heating coil 336. In some embodiments, heating coil 336 includes multiple stages of heating coils that can be independently activated and deactivated (e.g., by AHU controller 330) to modulate an amount of heating applied to supply air 310.

Each of valves 346 and 352 may be controlled by an actuator. For example, valve 346 may be controlled by actuator 354 and valve 352 may be controlled by actuator 356. Actuators 354-356 may communicate with AHU controller 330 via communications links 358-360. Actuators 354-356 may receive control signals from AHU controller 330 and may provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 may also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU controller 330 may control the temperature of supply air 310 and/or building zone 306 by activating or deactivating coils 334-336, adjusting a speed of fan 338, or a combination of both.

### Smart Connected HVAC Equipment

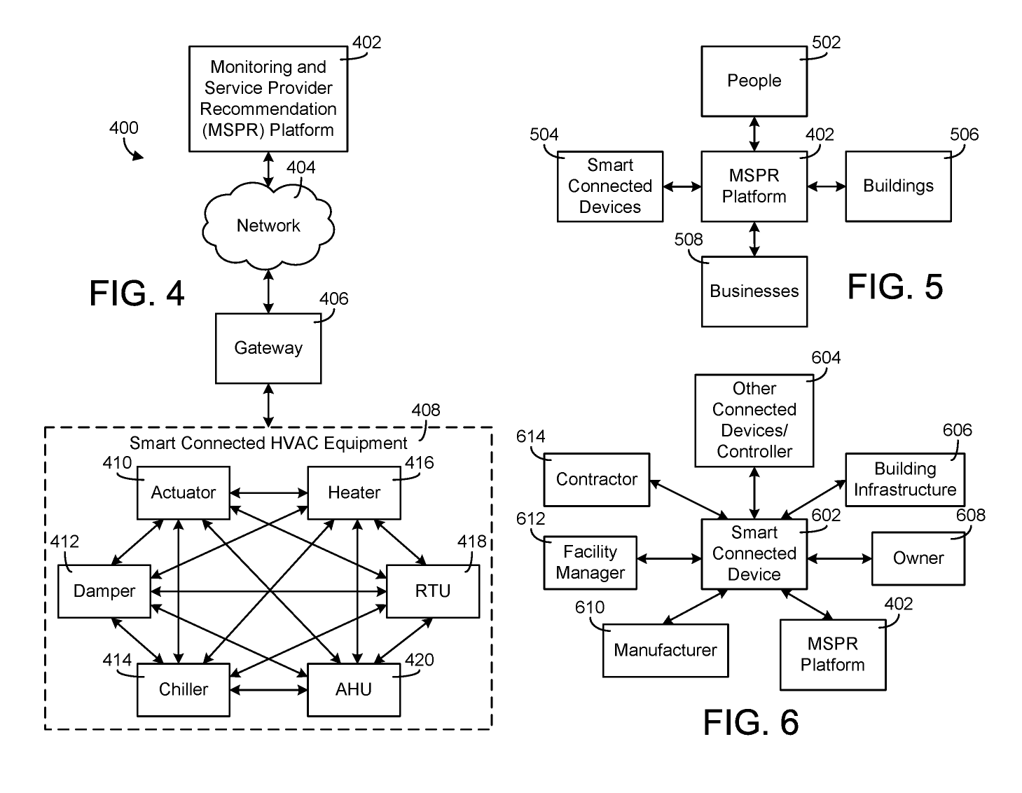

Referring now to FIG. 4, a system 400 of smart connected HVAC equipment 408 is shown, according to an exemplary embodiment. Smart connected HVAC equipment 408 may include an actuator 410, a damper 412, a chiller 414, a heater 416, a rooftop unit (RTU) 418, an air handling unit (AHU) 420, and/or any other type of equipment or device that can be installed within building 10 (e.g., fans, pumps, valves, etc.). Although the present invention is described primarily with reference to HVAC equipment, it should be understood that the systems and methods described herein may be applicable to a wide variety of building equipment and other types of connected devices (e.g., HVAC equipment, LED lights, mobile phones, elevators, fire safety systems, smart street lamps, cars, televisions, etc.) with embedded intelligence and communication capabilities.

Smart connected HVAC equipment 408 may be configured to communicate with each other and with remote services (e.g., remote monitoring and analytics services, cloud-based control services, etc.). In some embodiments, smart connected HVAC equipment 408 have ubiquitous connectivity (i.e., are always connected) and have their own processing and analytics capabilities. Smart connected HVAC equipment 408 may be managed in the cloud through various software applications and the analytics models built to control them. As such, a field/supervisory controller or building automation system may not be required. For example, a smart actuator that has built in position feedback, computing power, and a communication network can provide a cost-effective solution that can perform local decision making. A series of smart actuators and dampers that work together can provide completely autonomous manipulation of a building.

Smart connected HVAC equipment 408 may communicate with each other using any of a variety of communications protocols. In some embodiments, smart connected HVAC equipment 408 communicate with each other wirelessly using a wireless communications protocol (e.g. WiFi, Bluetooth, 3G/4G, 802.15.4, Zigbee, etc.). The particular communications protocol used by smart connected HVAC equipment 408 may be dependent upon the power requirements, bandwidth requirements, and/or the existing infrastructure within the building in which smart connected HVAC equipment 408 are installed. In some embodiments, smart connected HVAC equipment 408 communicate with each other using a proprietary building equipment protocol (e.g., BACNet, Zigbee, Modbus, etc.) to move data between various devices of smart connected HVAC equipment 408. In order to build applications on top of those protocols, these protocols may be converted into the Internet Protocol (IP). In some embodiments, a communications gateway us used for such a conversion.

In some embodiments, only a few of smart connected HVAC equipment 408 communicate with the outside network (e.g., a cellular network, a WAN, the Internet, etc.). Data may be exchanged between smart connected HVAC equipment 408 and then transmitted to the outside network by a subset of smart connected HVAC equipment 408. The types of data transmitted by smart connected HVAC equipment 408 may include, for example, measurements recorded by sensors integrated with smart connected HVAC equipment 408, device status information, diagnostic information, configuration information, device identity information, a software version, a hardware version, or any other information related to smart connected HVAC equipment 408 or the operation thereof. In order for the data to be consumed by the various software applications, a contextual protocol (e.g., RESTful API, CoAP, HTTP, AMQP, MQTT) may be used to provide contextual information on the data. An API may be used to share data with the external world using a clean abstraction.

Still referring to FIG. 4, system 400 is shown to include a communications gateway 406 and a network 404. Gateway 406 may be used to connect legacy and new equipment (e.g., temperature sensors, actuators, cooling or heating devices, industrial robots, personal health monitoring devices, etc.), to get the data from them, and in return to control them based on the instructions or analytical results from the remote services. Gateway 406 may provide network security, access control, and unique address of legacy devices' endpoints for remote access and protocol mediation services. In some embodiments, gateway 406 is a general-purpose gateway solution made by any of a variety of hardware manufacturers (e.g., Intel, FreeScale, Dell, Texas Instruments, etc.). In other embodiments, gateway 406 is a NCE or MAP gateway used specifically to connect building automation systems and smart equipment. Gateway 406 may use various Internet-based protocols (e.g., CoAP, XMPP, AMQP, MQTT, etc.) and web-based common data exchange (e.g., HTTP RESTful APIs) to translate communications from a building automation system protocol to an Internet protocol.

Network 404 may include the Internet and/or other types of data networks, such as a local area network (LAN), a wide area network (WAN), a cellular network, a satellite network, a radio network, or any other type of data network or combination thereof. Network 404 may include any number of computing devices (e.g., computers, servers, routers, network switches, etc.) configured to transmit, receive, or relay data. Network 404 may further include any number of hardwired and/or wireless connections. For example, smart connected HVAC equipment 408 may communicate wirelessly (e.g., using a WiFi or cellular radio, etc.) with a transceiver that is hardwired (e.g., via a fiber optic cable, a CAT5 cable, etc.) to a computing device of network 404.

Network 404 may include services that facilitate managing the fixed or wireless communication with smart connected HVAC equipment 408. Network vendors may include, for example, cellular telecommunications providers (e.g., Verizon, T-Mobile, AT&T, etc.) as well as internet service providers. Communications via network 404 may leverage enterprise contracts and partnerships to optimize the cost of data transmission. Many network carriers provide a secure connection option as a part of premium services. However, a similar degree of network securities can be achieved via employing trust platform chip in smart connected HVAC equipment 408 and using encrypted messaging such as AMQP via an Internet-based secure transport.

Still referring to FIG. 4, system 400 is shown to include a monitoring and service provider recommendation (MSPR) platform 402. MSPR platform 402 may operate as a remote system that receives and processes data provided by smart connected HVAC equipment 408 from many different buildings. MSPR platform 402 may leverage the data provided by smart connected HVAC equipment 408 to provide a variety of services. Services provided by MSPR platform 402 may include, for example, device management, data routing and real-time analytics, data management services, and batch analytics. Additionally, MSPR platform 402 may include monitoring and reporting applications, connected chiller applications, fault detection and diagnostics (FDD) applications, data analytics, and automated service provider recommendations. For example, a connected chiller (i.e., a type of smart connected HVAC equipment 408) may communicate with MSPR platform 402. The connected chiller application may integrate industry-leading remote monitoring and analysis tools with planned service agreements and warranties. This allows MSPR platform 402 to provide enhanced responsiveness and expertise to one of the most critical pieces of equipment in the facility.

Referring now to FIG. 5, MSPR platform 402 is shown as a central system that connects smart connected devices 504 (e.g., HVAC equipment and/or any other devices, smart connected HVAC equipment 408), buildings 506, people 502, and businesses 508. For example, smart connected devices 504 may provide their current status, analytics results, fault detections, measurements, identity information, equipment models that represent smart connected devices 504, and/or other information associated with smart connected devices 504 to MSPR platform 402. MSPR platform 402 may perform analytics on the data provided by smart connected devices 504. Analytics may be used to facilitate the various services provided by MSPR platform 402. For example, MSPR platform 402 may build statistical models that use data from smart connected devices 504 to infer patterns, perform comparisons, perform trend analyses and predictions, or even teach smart connected devices 504 to correct themselves (e.g., by providing adjusted operating parameters to smart connected devices 504).

MSPR platform 402 may use the data from smart connected devices 504 to determine how smart connected devices 504 are being used, to broaden the value proposition beyond the physical equipment, to include valuable data and value-added services, and to form closer relationships with customers. MSPR platform 402 may create usage reports for sales, marketing and product development to improve quality and create better pricing and product positioning. MSPR platform 402 may provide the usage reports to various people 502 (e.g., a building owner, a facility manager, etc.) to provide insight into how smart connected devices 504 are being used. In some embodiments, MSPR platform 402 augments data from smart connected devices 504 with external data (e.g., weather data, utility data, meter data, building occupancy, etc.) to provide extra information for better decision making.

The benefits provided by MSPR platform 402 include increased uptime for smart connected HVAC equipment 408, reduced future repair costs, extended asset life, using service experts with operational and trend data to assist in troubleshooting, and higher service renewal. MSPR platform 402 may be configured to implement a condition-based maintenance program to shorten the time to repair via remote diagnostics and optimized logistics in parts ordering and tool rentals. Potential outcomes of the services provided by MSPR platform 402 include a decreased number of unplanned repairs, optimized routine maintenance intervals, and reduced routine maintenance.

Referring now to FIG. 6, a smart connected device 602 may be connected to a building infrastructure 606, an owner 608, MSPR platform 402, a manufacturer 610, a facility manager 612, a contractor 614, and/or other smart connected devices and controllers 604. Smart connected device 602 may transmit its current status, analytics results, fault detections, measurements, its identity, an equipment model that represents smart connected device 602, and/or other information to the various entities with which smart connected device 602 is connected. For example, a smart connected rooftop may interact with an owner 608, an occupant, an OEM, and a contractor directly. A rooftop failure or failure symptom may be sent to MSPR platform 402 to orchestrate replacement or initiate a maintenance project. MSPR platform 402 may send alerts and a list of local service providers to the building owner 608. Thereby, certified contractors 614 who subscribe to MSPR platform 402 may have a higher chance to win the service contract. The service provider recommendation features of MSPR platform 402 are described in greater detail below.

### Automated Monitoring and Diagnostics to Improve Products and Services

MSPR platform 402 may use the data provided by smart connected HVAC equipment 408 to develop improved products and/or services. Developing improved products and services may include improving existing products and services as well as developing new products and services. For example, MSPR platform 402 may determine how to improve the operation of smart connected HVAC equipment 408 (e.g., optimizing energy consumption in a building, maintaining uptime of the equipment, etc.). MSPR platform 402 may use the remote diagnostics and repair to reduce downtime and unscheduled maintenance. In some embodiments, MSPR platform 402 creates a continuous feedback loop of how the customer uses smart connected HVAC equipment 408 to inform design, engineering and manufacturing decisions, to make the equipment better. MSPR platform 402 may also send automatic software updates to smart connected HVAC equipment 408 to add features and improve the performance of the equipment without any physical intervention.

In some embodiments, MSPR platform 402 uses the data provided by smart connected HVAC equipment 408 to help customers operate the equipment better and to enable service technicians to service the equipment better. The connectivity provided by smart connected HVAC equipment 408 allows MSPR platform 402 to monitor the equipment for critical alarms and notify service technicians if any issues arise. As the amount of collected data increases, the analytics model used by MSPR platform 402 continues to learn and improve over time. The analytics model may use the information from smart connected HVAC equipment 408 to identify opportunities for creating new physical products or even new information products. For example, MSPR platform 402 may identify opportunities to combine the functionality of two or more existing products (e.g., a video camera within a LED light bulb) to develop a new and improved product. The new and improved products may include, for example, a sensor or controller that can perform diagnostics and self-troubleshooting and/or other types of functionality that may eliminate the need for other products.

Advantageously, the connectivity provided by smart connected HVAC equipment 408 may facilitate a ubiquitous connection of various types of equipment within a building. Machine learning provided by MSPR platform 402 may use information provided by smart connected HVAC equipment 408 to develop a comprehensive view of controls in the building environment. In some embodiments, MSPR platform 402 provides building operators with a visually clean and intuitive view of the building operations and the ability to resolve issues in real-time. As more information is gathered regarding the patterns of how the building works, and under what circumstances and parameters, this information can be used by people outside of the manufacturing and building industry to improve products and services that affect the building.

MSPR platform 402 may allow vendors of HVAC equipment and related services to sell more of their products and services. For example, MSPR platform 402 may generate usage information that can be used to develop a better understanding of the lifecycle and usage of the HVAC equipment. This information may also enable service providers to sell more services proactively. For example, MSPR platform 402 may use the lifecycle information for a particular type of HVAC equipment to determine when that HVAC equipment is expected to require maintenance or replacement. MSPR platform 402 may then recommend preventative maintenance and/or replacement before a failure occurs. Such information may also allow an equipment vendor to optimize sales channels to sell more equipment and parts.

MSPR platform 402 may reduce service operational costs and increase efficiency. For example, advanced diagnostics and remote monitoring capabilities provided by MSPR platform 402 may reduce the time required for a service technician to troubleshoot an issue. This may reduce the time spent performing service calls and may improve productivity.

MSPR platform 402 may enhance the value of installed equipment. For example, MSPR platform 402 can analyze the usage information from smart connected HVAC equipment 408 to provide insights to customers and optimize the performance of the HVAC equipment 408. A building owner or operator can interact with MSPR platform 402 (e.g., via a monitoring and control interface) to obtain current status information, control parameters, diagnostic information, and other types of information related to the installed equipment (e.g., equipment manuals, warranty information, etc.). The control functionality provided by MSPR platform 402 may make controls seamless and transparent to building owners and operators.

MSPR platform 402 may create more value for customers with minimal physical contact with smart connected HVAC equipment 408. For example, MSPR platform 402 may automatically send updates to smart connected HVAC equipment 408 to enhance features and fix bugs. Analytics provided by MSPR platform 402 may provide customers with information (e.g., via an interface of a mobile device) to act upon on potential failures in their equipment or building.

MSPR platform 402 may allow an equipment/service vendor to increase its customer base with better differentiated products and services. For example, MSPR platform 402 can recommend specific types of equipment and/or services that would provide value to a customer based on the usage information gathered from the customer's equipment. Additionally, MSPR platform 402 as a whole can be provided as a service to new and existing customers.

MSPR platform 402 may create new business models and opportunities. For example, MSPR platform 402 may allow a contractor to increase the number of service contracts and margins. The usage information from smart connected HVAC equipment 408 can also be provided to an insurance provider. The insurance provider may use the usage information to determine an appropriate risk level for a building, which allows the insurance provider to set more accurate insurance premiums. The proactive repair and replacement suggestions provided by MSPR platform 402 may decrease the number of failures (e.g., by repairing or replacing equipment before failures occur), which reduces insurance claims and improves the margins of an insurance contract.

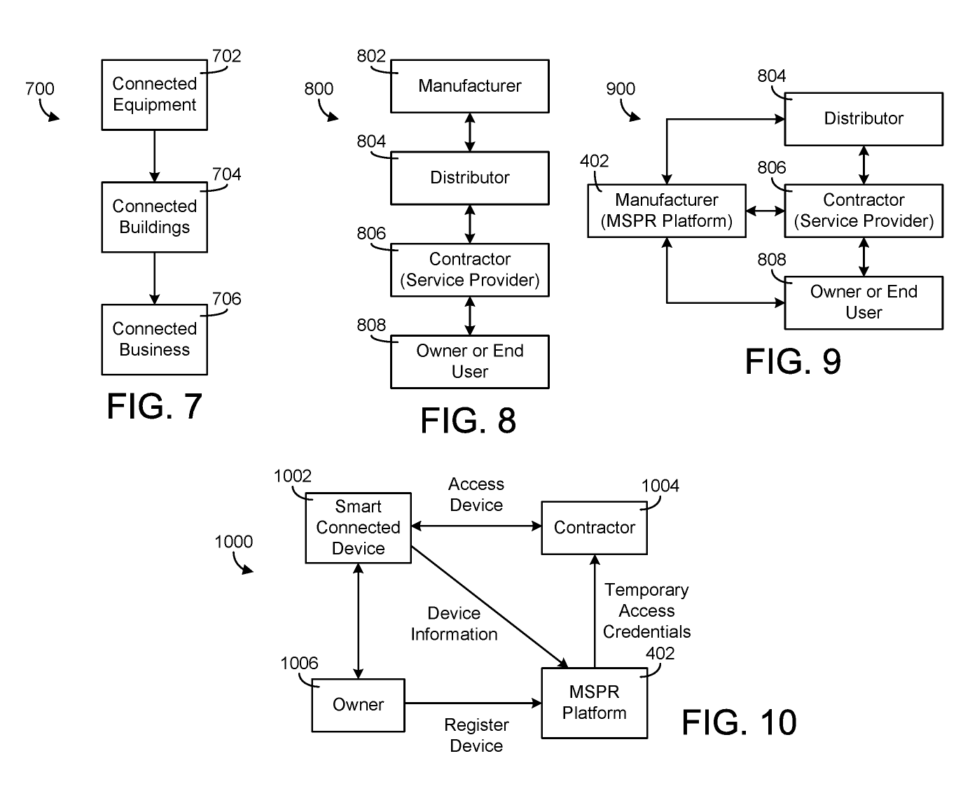

Referring now to FIG. 7, a process 700 for implementing MSPR platform 402 is shown, according to an exemplary embodiment. Process 700 is shown to include three stages: connected equipment 702, connected buildings 704, and connected business 706. Each of these stages can be implemented by making changes to sensors, data collection, and a business model. Changes to sensors may include changes made to physical devices and equipment. Each device or manufactured part becomes a sensor of the environment that they are actuating. Changes to data collection may include changes in the systematic collection, management, and analysis of the data that collected from the sensors (i.e., smart connected HVAC equipment 408). Changes to the business model may include changes that can be made to monetize the features provided by MSPR platform 402.

In connected equipment stage 702, ubiquitous connectivity of smart connected HVAC equipment 408 in a building may be provided. MSPR platform 402 may use data analytics to analyze information provided by smart connected HVAC equipment 408. Such data analytics may include, for example, modeling, graphing, and scaling out the information provided by smart connected HVAC equipment 408. Data analytics may further include real-time data analytics and machine learning.

Changes to the business model may include improving existing businesses (e.g., making them more efficient) and improving existing products. MSPR platform 402 may offer data analytics products as a service (e.g., with monthly billing) to allow building operators to get a clean and holistic view of the data associated with their buildings from mobile devices. Service technicians may also access the clean and holistic view of the data associated with a building to easily diagnose and repair problems more efficiently. Existing products can be offered as a service rather than product ownership. For example, a building owner or operator may subscribe to MSPR platform 402 (e.g., paying a monthly subscription fee), which provides access to the information provided by MSPR platform 402 including alerts when service and/or repair is recommended. Usage data from smart connected HVAC equipment 408 may be used to improve manufacturing reactively by detecting and fixing problems with equipment parts.

In connected buildings stage 704, information from smart connected HVAC equipment 408 can be aggregated across buildings to improve the capabilities and efficiency of smart connected HVAC equipment 408 (e.g., improving the autonomous control decisions made by the HVAC equipment). MSPR platform 402 may develop richer and more flexible models to integrate data from different buildings (e.g., richer schema). MSPR platform 402 may also develop richer analytical models (e.g., graph and probabilistic models) to deal with data heterogeneity and the added complexity of modeling across buildings (e.g., using other data to add context such as local/national laws and environmental/weather related operational considerations).

Changes to the business model may include expanding the services from connected equipment stage 702. Predictive analytics may be used to forecast a future electricity bill for the building based on historical data for other buildings in the region). A manufacturer, distributor, or service provider can use the information provided by MSPR platform 402 to guarantee equipment uptime (e.g., 95% uptime) or indoor temperature. MSPR platform 402 may monetize such information by charging monthly/annual service fees or by taking percentage of the cost savings.

Changes to the business model may further include changing the customer relationships and the value chain. For example, customer relationships may change from one-off purchases and services to more of a continuous consultative sales relationship, thereby increasing the lifetime value of a customer. MSPR platform 402 may establish direct relationships with customers (e.g., building owners) by providing customers with access to the monitoring information and service provider recommendations generated by MSPR platform 402.

In connected business stage 706, smart connected HVAC equipment 408 may be augmented with its own computing power and control capabilities. New features may be added to the data analytics, monitoring, reporting, and service provider recommendations generated by MSPR platform 402.

Changes to the business model may use data as a form of currency. For example, the data gathered from smart connected HVAC equipment 408 can be monetized in HVAC-related products, services, and markets (e.g., by selling more equipment, repair services, etc.), as well as in other industries. MSPR platform 402 may aggregate relevant data and models for the components, equipment and people across multiple different buildings. The data can be segmented by different regions, building types, age, size, and other factors. In some embodiments, MSPR platform 402 provides the data to insurance companies, which may use the data to refine their actuarial model and create pricing that's based on true usage and occupants behaviors. MSPR platform 402 may also provide insurance companies with data from water leakage detection sensors integrated with some types of smart connected HVAC equipment 408 (e.g., connected rooftop units) to provide an early warning of potential water damage.

In some embodiments, MSPR platform 402 provides the data to utilities, which may use the data to understand the energy usage profiles of the buildings and help them better manage the grid and the infrastructure that they need to build. In some embodiments, MSPR platform 402 provides the data to governmental agencies (e.g., city, state, national, etc.), which may use the data for better planning and allocation of resources. In some embodiments, MSPR platform 402 provides the data to energy storage companies, which may use the data to estimate the amount of energy generated by the buildings. MSPR platform 402 may help building owners to optimize equipment performance and connect them with the contractors to fix problems.

### Manufacturer-Centric Customer Relationships

Referring now to FIG. 8, a block diagram 800 illustrating a traditional customer relationship in the HVAC industry is shown. In the traditional customer relationship, an equipment manufacturer 802 provides HVAC equipment to a distributor 804. Distributor 804 receives purchase orders from a contractor 806 (e.g., a reseller or service provider) and provides the HVAC equipment to contractor 806. Contractor 806 then installs the HVAC equipment in the building of an owner or end user 808. Manufacturer 802 interacts only with distributor 804 and has no contact with building owner or end user 808 of the HVAC equipment. Once the HVAC equipment is installed, owner or end user 808 interacts only with contractor 806 if the HVAC equipment requires service or replacement.

Referring now to FIG. 9, a block diagram 900 illustrating a manufacturer-centric customer relationship made possible by MSPR platform 402 is shown. In the manufacturer-centric customer relationship, manufacturer 802 uses MSPR platform 402 to interact directly with distributor 804, contractor 806, and building owner or end user 808. Smart connected HVAC equipment 408 within the building of owner or end user 808 communicates with MSPR platform 402, which may be owned or operated by manufacturer 802. For example, smart connected HVAC equipment 408 may transmit its current status, analytics results, fault detections, measurements, its identity, an equipment model that represents smart connected HVAC equipment 408, a software version, a hardware version, and/or other information to MSPR platform 402. MSPR platform 402 may use the data from smart connected HVAC equipment 408 to automatically detect and diagnose faults and to determine appropriate replacement or repair actions for smart connected HVAC equipment 408. MSPR platform 402 may send alerts and a list of local contractors 806 (e.g., service providers) to the building owner 808. The building owner 808 may then select one of contractors 806 to service the HVAC equipment.

The manufacturer-centric customer relationship represents a fundamental shift in managing customer relationships in the HVAC industry. This relationship change may result in weaker dependency on distributors 804 and contractors 806. Manufacturer 802 now has the opportunity to capture more profits from the overall value chain. Furthermore, manufacturer 802 can use the data received from smart connected HVAC equipment 408 to learn how its products and features are being accessed and utilized.

A detected fault represents repair or replacement opportunity for smart connected HVAC equipment 408, which becomes revenue for contractor 806 and a part sale opportunity for distributor 804. MSPR platform 402 may present these opportunities to both contractor 806 and distributor 804 to capture business in almost real-time. Given an informed fault (e.g., a fault accompanied by diagnostic information), contractor 806 may prepare a service cost estimate based on service part availability and diagnostic results. Contractor 806 may submit a bid to MSPR platform 402, which provides the bid, along with bids from other contractors, to building owner 808. Building owner 808 can select a contractor 806 based on the bid information and service proposals. Once a contractor 806 is selected, MSPR platform 402 may inform the selected contractor 806 that it has won the service contract.

### Access to Smart Connected HVAC Devices

Referring now to FIG. 10, a block diagram 1000 illustrating the types of information provided between a smart connected device 1002, a building owner 1006, MSPR platform 402, and a contractor 1004 is shown, according to an exemplary embodiment. When smart connected device 1002 is installed, building owner 1006 may register smart connected device 1002 with MSPR platform 402. In some embodiments, smart connected device 1002 is provisioned in such a way that only building owner 1006 (and possibly MSPR platform 402) has access to smart connected device 1002. Smart connected device 1002 sends device information (e.g., status, identity, diagnostic results, measurements, etc.) to MSPR platform 402.

When a repair or replacement opportunity is identified by MSPR platform 402, MSPR platform 402 may provide temporary access credentials to contractor 1004. Contractor 1004 may use the temporary access credentials to access smart connected device 1002 and obtain detailed status and diagnostic information from smart connected device 1002. The temporary access credentials may expire after a defined time period or upon completion of a defined action (e.g., completing service on the smart connected device) which prevents contractor 1004 from accessing smart connected device 1002 once the service contract is complete.

### Self-Conscious Buildings

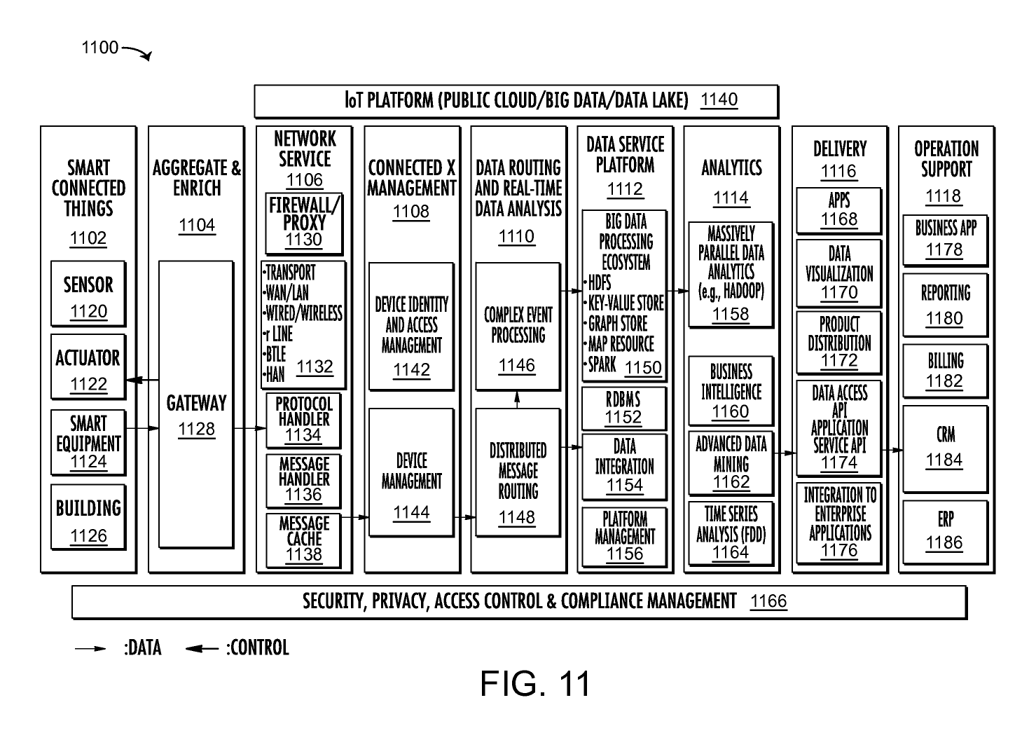

Referring now to FIG. 11, a block diagram illustrating the components of an ecosystem 1100 in which MSPR platform 402 may be implemented is shown, according to an exemplary embodiment. Ecosystem 1100 may allow MSPR platform 402 to facilitate self-conscious buildings that include smart connected HVAC equipment 408. Many different types of partnerships may be used to facilitate self-conscious buildings. Examples of such partnerships include regional partnerships, global partnerships, channel partnerships, industry organization, and technology partners. In FIG. 11, each vertical column 1102-1118 represents technology components that could be installed in the self-conscious building, provided by MSPR platform 402, or purchased from or co-developed with a vendor or partner.

Ecosystem 1100 is shown to include smart connected things 1102 (e.g., sensors 1120, actuators 1122, smart equipment 1124, smart buildings 1126, etc.). Smart connected things 1102 may include an actuator, a damper, a chiller, a heater, a rooftop unit (RTU), and an air handling unit (AHU), or any other type of equipment or device that can be installed within a building (e.g., fans, pumps, valves, etc.). Although the present invention is described primarily with reference to HVAC equipment, it should be understood that the systems and methods described herein may be applicable to a wide variety of building equipment and other types of connected devices (e.g., HVAC equipment, LED lights, mobile phones, elevators, fire safety systems, smart street lamps, cars, televisions, etc.) with embedded intelligence and communication capabilities.

Ecosystem 1100 is shown to include an aggregate and enrich component 1104 (e.g., gateway 1128) and network service 1106. Gateway 1128 may be used to connect legacy and new equipment (e.g., temperature sensors, actuators, cooling or heating devices, industrial robots, personal health monitoring devices, etc.), to get the data from them, and in return to control them based on the instructions or analytical results from the remote services. Gateway 1128 may provide network security, access control, and unique address of legacy devices' endpoints for remote access and protocol mediation services. In some embodiments, gateway 1128 is a general-purpose gateway solution made by any of a variety of hardware manufacturers (e.g., Intel, FreeScale, Dell, Texas Instruments, etc.). In other embodiments, gateway 1128 is a NCE or MAP gateway used specifically to connect building automation systems and smart equipment. Gateway 1128 may use various Internet-based protocols (e.g., CoAP, XMPP, AMQP, MQTT, etc.) and web based common data exchange (e.g., HTTP RESTful APIs) to translate communications from a building automation system protocol to an Internet protocol.

Network service 1106 may include the Internet and/or other types of data networks, such as a local area network (LAN), a wide area network (WAN), a cellular network, a satellite network, a radio network, or any other type of data network or combination thereof. Network service 1106 is shown to include a firewall/proxy 1130, transport protocols 1132 (e.g., WLAN/LAN, Zigbee, Wired/Wireless, PAN/BAN/Power Line, BTLE, HAN), protocol handlers 1134, a message handler 1136, and a message cache 1138. Network service 1106 may include any number of computing devices (e.g., computers, servers, routers, network switches, etc.) configured to transmit, receive, or relay data. Network service 1106 may further include any number of hardwired and/or wireless connections. For example, smart connected HVAC equipment 408 may communicate wirelessly (e.g., using a WiFi or cellular radio, etc.) with a transceiver that is hardwired (e.g., via a fiber optic cable, a CAT5 cable, etc.) to a computing device of network service 1106.

Network service 1106 may include services that facilitate managing the fixed or wireless communication with smart connected HVAC equipment 408. Network vendors may include, for example, cellular telecommunications providers (e.g., Verizon, T-Mobile, AT&T, etc.) as well as internet service providers. Communications via network service 1106 may leverage enterprise contracts and partnerships to optimize the cost of data transmission. Many network carriers provide a secure connection option as a part of premium services. However, a similar degree of network securities can be achieved via employing trust platform chip in smart connected HVAC equipment 408 and using encrypted messaging such as AMQP via an Internet-based secure transport.

Still referring to FIG. 11, ecosystem 1100 is shown to include an Internet of Things (IoT) platform 1140, which may be the same or similar to MSPR platform 402 previously described. For example, IoT platform 1140 may include device management functionality 1108 (e.g., device identity and access management 1142, device management 1144), data routing and real-time analytics 1110 (e.g., complex event processing 1146, distributed message routing 1148), data management services 1112 (e.g., big data processing 1150, RDBMS 1152, data integration 1154, and platform management 1156), and batch analytics 1114 (e.g., massively parallel data analytics 1158, business intelligence 1160, advanced data mining 1162, and time series analysis (FDD) 1164). Many large IT solution providers such as Microsoft, Intel, Cisco, Google, Amazon, SAP, Qualcomm and Oracle offer general-purpose solutions with developer tools for customization, while Axeda (now a part of PTC), ETHERIOS, ThingWorx and GE offers more vertically integrated industry solutions such as manufacturing. IoT platform 1140 may include a cloud service provider such as Microsoft, Google, or Amazon. IoT platform 1140 may include connected chiller applications, FDD applications, business analytics, and smart chiller control applications. In some embodiments, IoT platform 1140 leverages the industry's first hybrid architecture utilizing on-premise and public cloud (i.e., Microsoft Azure). IoT platform 1140 may use a subset of Microsoft IoT platform services to minimize vendor dependencies.

Ecosystem 1100 is shown to include, security, privacy, access control, and compliance management 1166. Security may be provided at both the device and network levels. The same intelligence that enables devices to perform their tasks may also enable them to recognize and counteract threats. This does not require an evolutionary approach, but rather an evolution of measures that have proven successful in IT networks, adapted to the challenges of IoT and to the constraints of connected devices. At any given point in time, IoT platform 1140 may support multiple users and stake holders including building owners, building operators, tenants, service technicians, manufacturers, and the like. Remote accessibility of connected products may involve complex identity management through a unified login and product management experience. For example, a single login may allow a customer to sign on to all connected products and services associated with IoT platform 1140.

Ecosystem 1100 is shown to include delivery 1116. Delivery 1116 is related to channel and distribution strategy and is shown to include product distribution 1172. Product distribution 1172 may include off-line distribution of IoT related products, services and on-line distribution of solution for a certain customer and/or a market (e.g., delivery applications 1168). APIs 1174 may be provided to app developers to deliver information products. Data visualization 1170 and exploration tools may be used for rapid delivery. Delivery 1116 may include integration to enterprise applications 1176.

Ecosystem 1100 is shown to include operation support 1118. Operation support 1118 may facilitate the integration and optimization of devices to unite interrelated applications. For example, if IoT platform 1140 includes financial transaction services, then CRM, ERP and/or financial payment service integration may be used. Operation support 1118 may further include business applications 1178 and reporting applications 1180 that facilitate providing the data from IoT platform 1140 to outside businesses (e.g., insurance companies, utility providers, governmental agencies, etc.) that may have an interest in such data. Operation support 1118 may further include CRM 1184 and ERP 1186.

### Automated Service Provider Recommendations

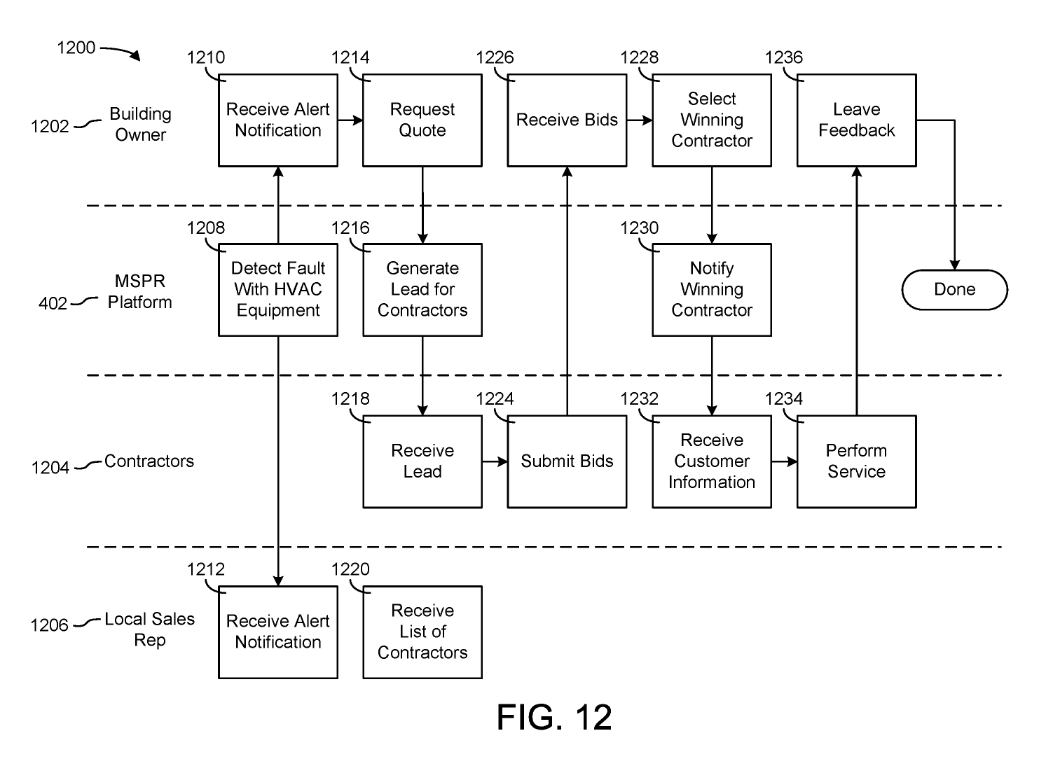

Referring now to FIG. 12, a block diagram illustrating a process 1200 for automated service provider recommendations is shown, according to an exemplary embodiment. As shown in FIG. 12, MSPR platform 402 interacts with a building owner 1202, contractors 1204, and local sales representatives 1206 to provide the automated service provider recommendations and support other activities related thereto.

Process 1200 begins with MSPR platform 402 detecting a fault with smart connected HVAC equipment 408 installed in a building (step 1208). The fault may be detected using information received from smart connected HVAC equipment 408. In some instances, MSPR platform 402 may proactively identify an opportunity for repairing or replacing the HVAC equipment (e.g., based on a history of service for the HVAC equipment or an expected life of the HVAC equipment) before a fault is detected. Both fault detections and identified opportunities for repairing or replacing the HVAC equipment may initiate the automated service provider recommendation process.

In response to detecting the fault or identifying the repair or replacement opportunity, MSPR platform 402 may provide an alert notification to the building owner (e.g., in the form of an email sent to the building owner) (step 1210). In some embodiments, MSPR platform 402 also provides the alert notification to a local sales representative 1206 (step 1212) who may contact building owner 1202 to discuss service options. Upon receiving the alert notification, building owner 1202 may request a quote (e.g., a price estimate) for repairing or replacing the faulty HVAC equipment (step 1214). In some embodiments, building owner 1202 requests the quote by clicking a link in the alert notification email or via a mobile application or web interface.

MSPR platform 402 responds to the quote request by generating a lead for contractors 1204 (step 1216). The lead may specify the type of HVAC equipment to be serviced (e.g., by model number or code), the location of the HVAC equipment (e.g., by city or address), and a description of the fault associated with the HVAC equipment (e.g., excessive low side pressure, high side heat transfer problem, insufficient refrigerant flow, etc.). MSPR platform 402 may identify one or more local contractors 1204 capable of servicing the HVAC equipment.

In some embodiments, MSPR platform 402 identifies suitable contractors 1204 based on the types of service that contractors 1204 perform, demographic information associated with contractors 1204 and/or building owner 1202, revenue or business growth of contractors 1204, and/or other contractor-related attributes that indicate contractors 1204 are capable of performing the requested service. In some embodiments, MSPR platform 402 selects suitable contractors 1204 from a database of contractors that have registered with or subscribed to MSPR platform 402. Once contractors 1204 are identified, MSPR platform 402 notifies contractors 1204 of the lead. In some embodiments, MSPR platform 402 sends a list of the identified contractors 1204 to local sales representative 1206 (step 1220).

Contractors 1204 receive the lead (step 1218) and submit bids (e.g., price quotes) for servicing the HVAC equipment (step 1224). Contractors 1204 may receive leads via email messages, a mobile application (e.g., for a tablet or smart phone), or via a web interface. Contractors 1204 may use the diagnostic information or problem description provided with the lead to determine an appropriate bid. In some embodiments, MSPR platform 402 automatically determines the cost of materials required to correct the fault and the cost of labor charged by contractors 1204. MSPR platform 402 may automatically generate a cost estimate and provide the cost estimate to contractors 1204 along with the lead. Contractors 1204 may adjust the cost estimate, if desired, and submit the bid to MSPR platform 402. MSPR platform 402 then provides the bids to building owner 1202.

Building owner 1202 receives the bids (step 1226) from MSPR platform 402 (e.g., via email, a mobile application, or a web interface) and selects a winning contractor/bid (step 1228). MSPR platform 402 receives the selected contractor from building owner 1202 and notifies the winning contractor that it has won the service contract (step 1230). The winning contractor may then receive customer information from MSPR platform 402 (step 1232) and may contact building owner 1202 to schedule a service appointment. In some embodiments, MSPR platform 402 automatically schedules the service appointment. In some embodiments, MSPR platform 402 provides the winning contractor with temporary access credentials, which can be used by the contractor to access the faulty HVAC equipment to perform remote diagnostics. The winning contractor then performs service on the faulty HVAC equipment (step 1234). After the service is complete, building owner 1202 can leave feedback with MSPR platform 402 regarding the service (step 1236).

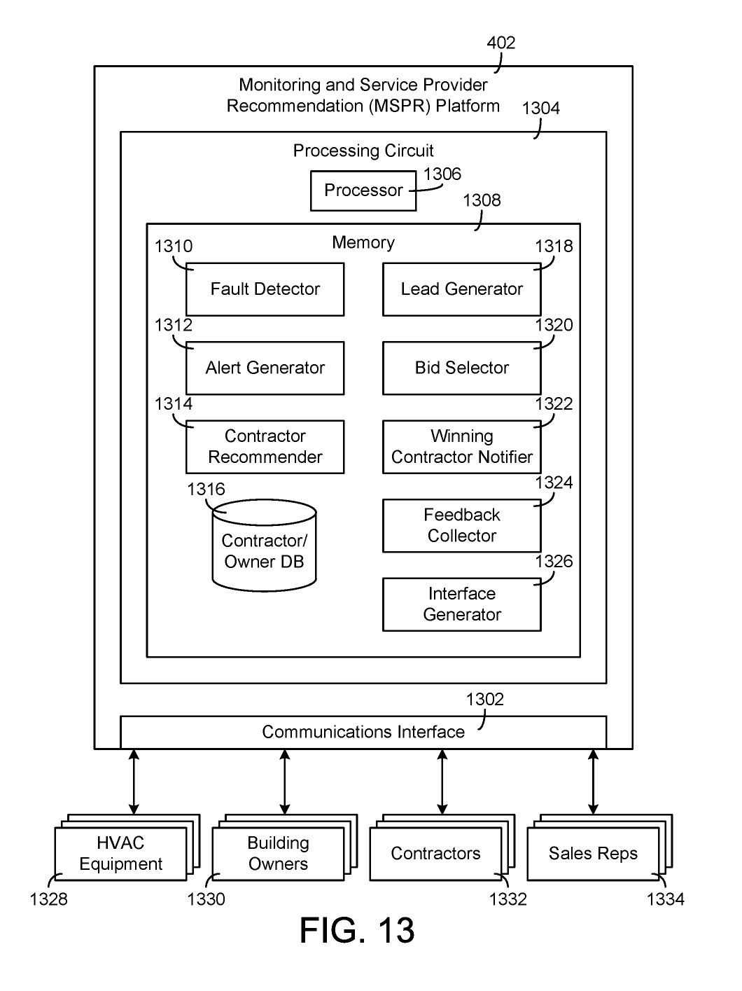

Referring now to FIG. 13, a block diagram illustrating MSPR platform 402 in greater detail is shown, according to an exemplary embodiment. MSPR platform 402 is shown to include a communications interface 1302 and a processing circuit 1304. Communications interface 1302 may include any number and/or type of wired or wireless communications interfaces (e.g., jacks, antennas, transmitters, receivers, transceivers, wire terminals, etc.) for conducting electronic data communications with external systems or devices. Communications via communications interface 1302 may be direct (e.g., local wired or wireless communications) or via a communications network (e.g., a WAN, the Internet, a cellular network, etc.). For example, communications interface 1302 may include an Ethernet card and port for sending and receiving data via an Ethernet-based communications link or network, a WiFi transceiver for communicating via a wireless communications network, a cellular or mobile phone communications transceiver, a power line communications interface, or any other type of wired or wireless communications interface.

Communications interface 1302 may facilitate communications between MSPR platform 402 and various external systems or devices. For example, communications interface 1302 may be used to communicate with HVAC equipment 1328, building owners 1330, contractors 1332, sales reps 1334, building management systems, building controllers, user devices, and/or other connected systems or devices. Communications interface 1302 may be communicably connected to processing circuit 1304 such that processing circuit 1304 and the various components thereof can send and receive data via communications interface 1302.

Processing circuit 1304 is shown to include a processor 1306 and memory 1308. Processor 1306 can be implemented as a general purpose processor, an application specific integrated circuit (ASIC), one or more field programmable gate arrays (FPGAs), a group of processing components, or other suitable electronic processing components. Memory 1308 (e.g., memory, memory unit, storage device, etc.) may include one or more devices (e.g., RAM, ROM, Flash memory, hard disk storage, etc.) for storing data and/or computer code for completing or facilitating the various processes, layers and modules described herein. Memory 1308 may be or include volatile memory or non-volatile memory. Memory 1308 may include database components, object code components, script components, or any other type of information structure. According to an exemplary embodiment, memory 1308 is communicably connected to processor 1306 via processing circuit 1304 and includes computer code for executing (e.g., by processing circuit 1304 and/or processor 1306) one or more processes described herein.

Still referring to FIG. 13, MSPR platform 402 is shown to include a fault detector 1310. Fault detector 1310 may receive information from HVAC equipment 1328, which may be the same or similar to smart connected HVAC equipment 408 and/or smart connected devices 504, 602 as described with reference to FIGS. 4-6. For example, HVAC equipment 1328 may be installed in a building and configured to communicate with MSPR platform 402. Fault detector 1310 may detect a fault with HVAC equipment 1328. The fault may be detected using information received from HVAC equipment 1328. In some instances, fault detector 1310 proactively identifies an opportunity for repairing or replacing HVAC equipment 1328 (e.g., based on a history of service for HVAC equipment 1328 or an expected life of HVAC equipment 1328) before a fault is detected. Both fault detections and identified opportunities for repairing or replacing HVAC equipment 1328 may initiate the automated service provider recommendation process.

MSPR platform 402 is shown to include an alert generator 1312. Alert generator 1312 may receive notifications of detected faults and/or repair or replacement opportunities from fault detector 1310. In response to detecting the fault or identifying the repair or replacement opportunity, alert generator 1312 may provide an alert notification to building owner 1330 (e.g., in the form of an email sent to the building owner). In some embodiments, alert generator 1312 also provides the alert notification to sales representative 1334, who may contact building owner 1330 to discuss service options. Upon receiving the alert notification, building owner 1330 may request a quote (e.g., a price estimate) for repairing or replacing HVAC equipment 1328. In some embodiments, building owner 1330 requests the quote by clicking a link in the alert notification email or via a mobile application or web interface.

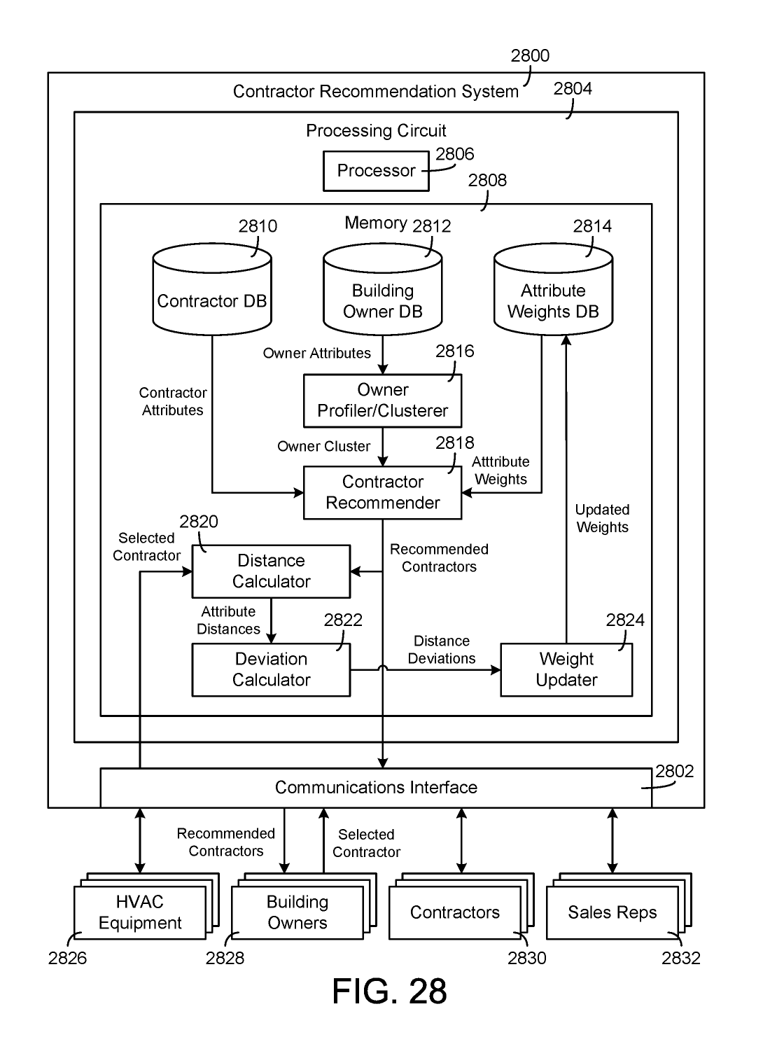

Still referring to FIG. 13, MSPR platform 402 is shown to include a contractor recommender 1314. Contractor recommender 1314 may be implemented as a component of MSPR platform 402 (as shown in FIG. 13) or as a separate contractor recommendation system (as shown in FIG. 28. Contractor recommender 1314 may be configured to recommend one or more contractors for repairing or replacing HVAC equipment 1328. In some embodiments, contractor recommender 1314 determines which of a plurality of contractors to recommend to building owner 1330. For example, contractor recommender 1314 may select a subset of contractors 1332 from a database of contractors 1332 (e.g., contractor/owner database 1316) and provide a listing of the selected subset of contractors 1332 to building owner 1330.

Contractor recommender 1314 may use a variety of criteria to select recommended contractors. For example, contractor recommender 1314 may consider contractor attributes such as the proximity/distance from the building owner 1330, consumer rating or reputation score, a number of years in service, credit score, average time to completion, a number of outstanding claims, annual revenue, average growth rate, average labor rate, liability, insurance, number of employees, ethnic background, whether the contractor has previously worked with the building owner 1330, and/or other attributes that can be used to describe or characterize contractors 1332. Contractor recommender 1314 may consider owner or building attributes such as the type of building, building location, building size, vertical market, annual spending on HVAC, and/or other attributes that can be used to describe or characterize the buildings containing HVAC equipment 1328 to be serviced and/or building owners 1330. Contractor attributes and owner attributes may be stored in contractor/owner database 1316.

In some embodiments, contractor recommender 1314 uses the owner attributes to generate user profiles for building owners 1330 and assign building owners 1330 to one or more clusters. Building owners 1330 may be clustered based on the owner attributes and/or relevance feedback from building owners 1330. Relevance feedback may include, for example, selections made by building owners 1330 when presented with a list of recommended contractors. In some embodiments, the contractor selections made by all the building owners 1330 assigned to a particular cluster are categorized as relevance feedback of the cluster. This allows contractor recommender 1314 to use similarities between building owners 1330 to predict which types of contractors 1332 are likely to be selected by a cluster of building owners 1330.

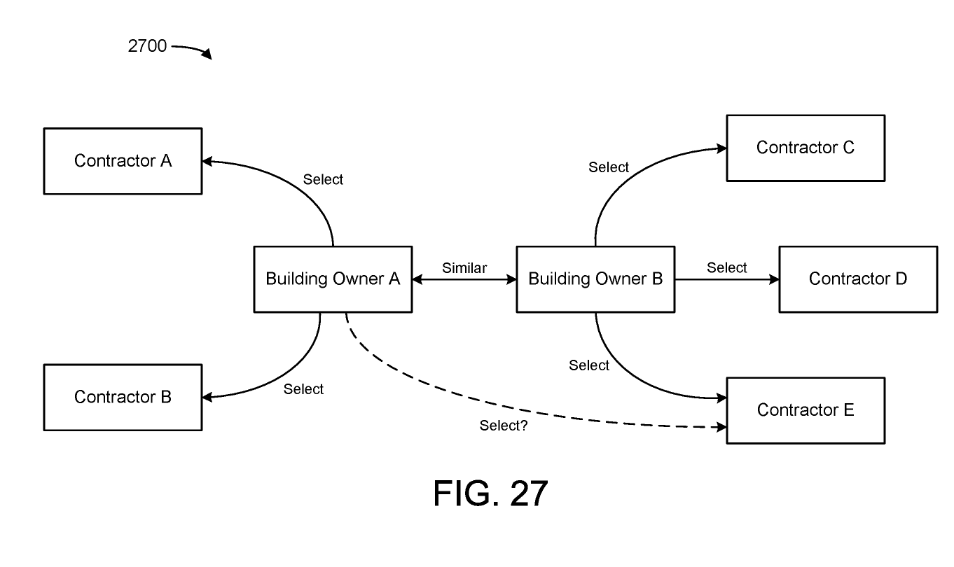

Contractor recommender 1314 may use the contractor selections made by a cluster of building owners 1330 to automatically determine which of the contractor attributes are most important to the cluster of building owners 1330. For example, if a cluster of building owners 1330 selects multiple contractors 1332 having similar values for a particular contractor attribute, contractor recommender 1314 may increase a weight assigned to the contractor attribute. Advantageously, this allows contractor recommender 1314 to automatically establish a subjectivity model for the cluster of building owners 1330 without requiring the building owners 1330 to define which of the contractor attributes are most important. The subjectivity modeling performed by contractor recommender 1314 is described in greater detail with reference to FIGS. 27-28.

Still referring to FIG. 13, MSPR platform 402 is shown to include a lead generator 1318. Lead generator 1318 may receive a request for a quote from building owners 1330 and generate a lead for contractors 1332. In some embodiments, lead generator 1318 provides the lead to the subset of contractors 1332 selected by contractor recommender 1314. The lead may specify the type of HVAC equipment 1328 to be serviced (e.g., by model number or code), the location of HVAC equipment 1328 (e.g., by city or address), and/or a description of the fault associated with HVAC equipment 1328 (e.g., excessive low side pressure, high side heat transfer problem, insufficient refrigerant flow, etc.). In some embodiments, lead generator 1318 provides a list of the recommended contractors and/or leads to sales representative 1334.

Contractors 1332 receive the lead and submit bids (e.g., price quotes) for servicing HVAC equipment 1328. Contractors 1332 may receive leads via email messages, a mobile application (e.g., for a tablet or smart phone), or via a web interface. Contractors 1332 may use the diagnostic information or problem description provided with the lead to determine an appropriate bid. In some embodiments, lead generator 1318 automatically determines the cost of materials required to correct the fault and the cost of labor charged by the contractor. Lead generator 1318 may automatically generate a cost estimate and provide the cost estimate to contractors 1332 along with the lead. Contractors 1332 may adjust the cost estimate, if desired, and submit the bid to MSPR platform 402.

Still referring to FIG. 13, MSPR platform 402 is shown to include a bid selector 1320 and a winning contractor notifier 1322. Bid selector 1320 may receive bids from contractors 1332 and provide the bids to building owners 1330. Building owners 1330 receives the bids from bid selector 1320 (e.g., via email, a mobile application, or a web interface) and select a winning contractor/bid. Bid selector 1320 receives the selected contractor from the building owner and provides an indication of the selected contractor to winning contractor notifier 1322.

Winning contractor notifier 1322 notifies the winning contractor that it has won the service contract. The winning contractor may then receive customer information from winning contractor notifier 1322 and may contact the building owner to schedule a service appointment. In some embodiments, winning contractor notifier 1322 automatically schedules the service appointment. In some embodiments, winning contractor notifier 1322 provides the winning contractor with temporary access credentials, which can be used by the contractor to access the faulty HVAC equipment 1328 to perform remote diagnostics. The contractor then performs service on the faulty HVAC equipment 1328. After the service is complete, building owners 1330 can leave feedback with feedback collector 1324 regarding the service.

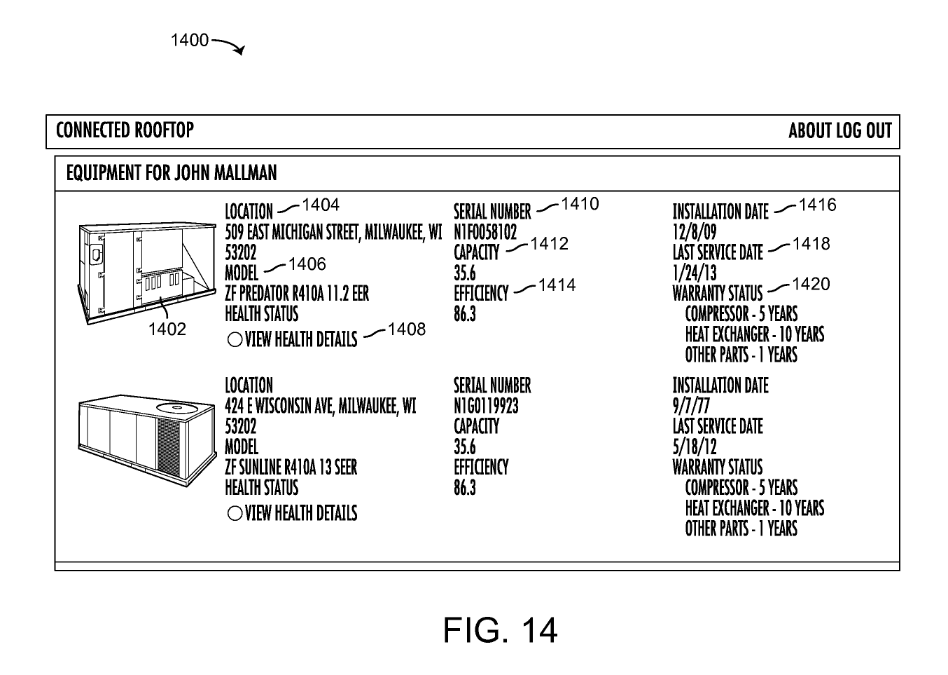

Still referring to FIG. 13, MSPR platform 402 is shown to include an interface generator 1326. Interface generator 1326 may be configured to generate one or more user interfaces which may be provided to building owners 1330, contractors 1332, sales representatives 1334, and/or other users interacting with MSPR platform 402. Several exemplary user interfaces which may be generated by interface generator 1326 are described in detail with reference to FIGS. 14-26.

### User Interfaces

Referring now to FIGS. 14-17, several a user interface 1400-1700 which may be provided to the building owner by MSPR platform 402 is shown, according to an exemplary embodiment. The building owner may create an account with MSPR platform 402 and register the HVAC equipment owned by the building owner. The building owner can login to his or her account to monitor the status of the HVAC equipment and view detailed health details and other information associated with the HVAC equipment. Although owner interface 1400-1700 is shown as a web interface, owner interface 1400-1700 may be provided via an application for a mobile device in various other embodiments.

FIG. 14 is an example of a web interface 1400 which may be provided to the building owner by MSPR platform 402. Owner interface 1400 may list all of the HVAC equipment registered to the building owner and may provide detailed information pertaining to the HVAC equipment. For example, owner interface 1400 is shown to include a pictorial representation 1402 of the HVAC equipment, the location 1404 of the HVAC equipment, the model 1406 of the HVAC equipment, a link 1408 to view the health details of the HVAC equipment, the serial number 1410 of the HVAC equipment, the capacity 1412 of the HVAC equipment, the efficiency 1414 of the HVAC equipment, the installation date 1416 of the HVAC equipment, the last service date 1418 of the HVAC equipment, and the status 1420 of any warranties associated with the HVAC equipment and/or various parts thereof (e.g., compressor, heat exchanger, etc.). In some embodiments, owner interface 1400 includes a link to a product manual for the HVAC equipment.

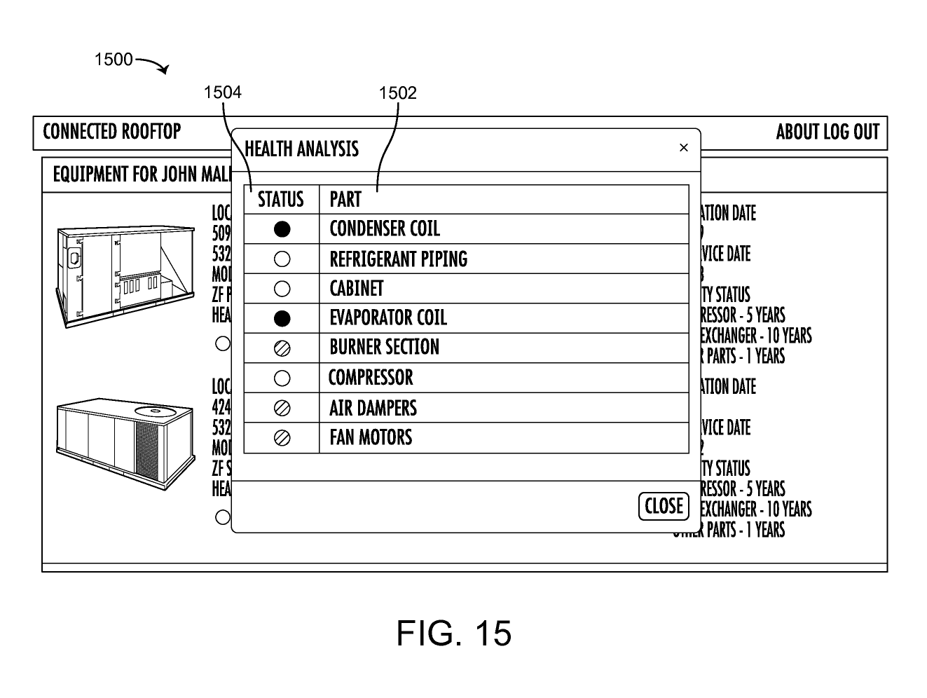

FIG. 15 is an example of an interface 1500 which may be provided to the building owner upon clicking the link to view the health status of the HVAC equipment. Health status interface 1500 includes a listing of the various parts 1502 of the HVAC equipment (e.g., condenser coil, refrigerant piping, cabinet, evaporator coil, compressor, etc.) as well as a health indicator 1504 associated with each part (e.g., a green dot for good health, a yellow dot for moderate health, and a red dot for poor health).

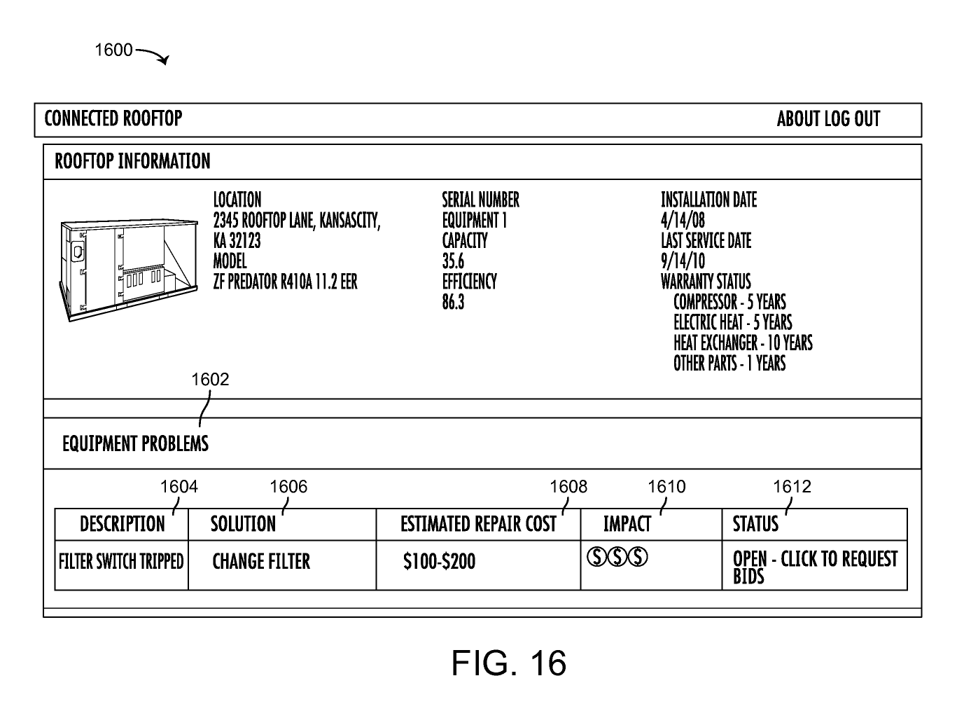

FIG. 16 is an example of an interface 1600 which may be provided to the building owner when a problem is detected with the HVAC equipment. Interface 1600 is shown to include an equipment problems block 1602 which includes a description 1604 of the detected problem (e.g., filter switch tripped), a suggested solution 1606 to the detected problem (e.g., change filter), an estimated repair cost 1608 (e.g., $100-$200), and an indication of the financial impact 1610 of the problem if the problem is left unrepaired.

Interface 1600 is also shown to include a status indicator 1612 which may display the current status of the automated service provider recommendation and service process. When the problem is initially detected, status indicator 1612 may indicate that the status is open. Clicking status indicator 1612 may cause MSPR platform 402 to automatically request bids from various contractors capable of servicing the HVAC equipment. Status indicator 1612 may update to reflect the current status of the service process (e.g., bids requested, bids received, work awarded, service complete, etc.). When the building owner selects a contractor, status indicator 1612 may update to indicate that the work has been awarded to the selected contractor for the quoted price. Status indicator 1612 may also indicate the scheduled time of service (e.g., Work Awarded: JMC Contracting, on or before Nov. 29, 2015, for $1400).

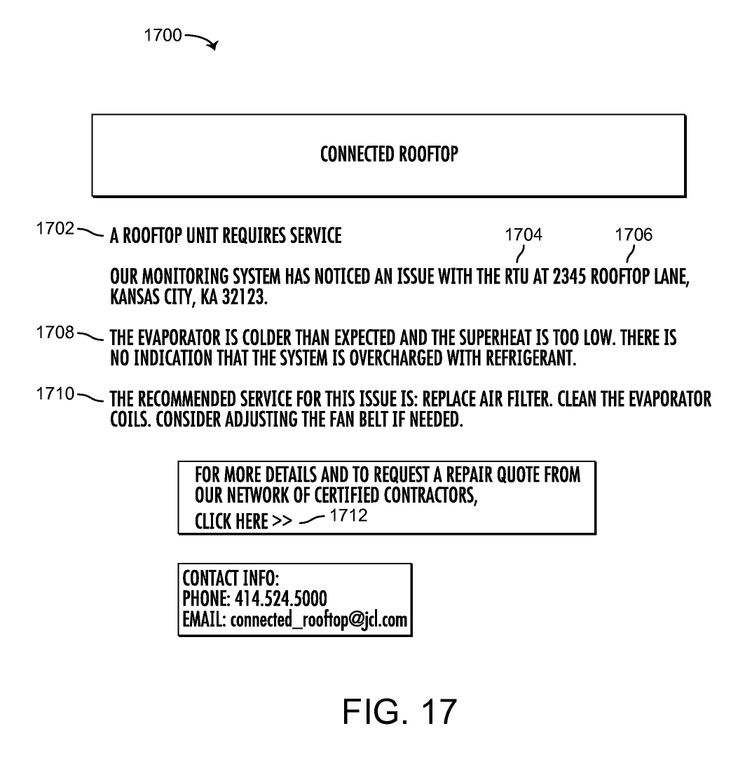

FIG. 17 is an example of an email message 1700 which may be provided to the building owner by MSPR platform 402 when a problem is detected with the HVAC equipment. Email message 1700 is shown to include a notification 1702 that HVAC equipment requires service and may identify the HVAC equipment by type 1704, location 1706, model number, serial number, and/or other attributes which describe the HVAC equipment. Email message 1700 may include an indication of the problem 1708 and a recommended action 1710 for repairing the problem. Email message 1700 may also include a link 1712 that can be selected (i.e., clicked) by the building owner to cause MSPR platform 402 to automatically request bids from various contractors capable of servicing the HVAC equipment.

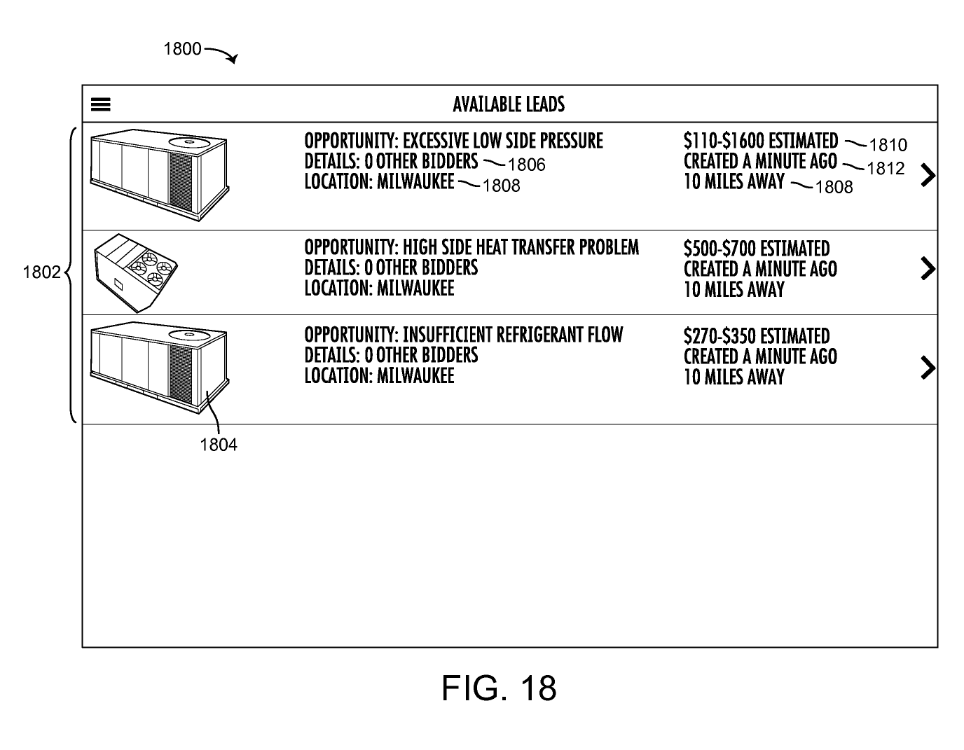

Referring now to FIGS. 18-20 a user interface 1800-2000 which may be provided to the contractor by MSPR platform 402 is shown, according to an exemplary embodiment. The contractor may create an account with MSPR platform 402 and specify the location of the contractor, the types of service performed by the contractor, and/or other details related to the contractor's business. The contractor can login to his or her account to view available leads and to submit bids to MSPR platform 402. Although the contractor interface is shown as an interface for a mobile device, the contractor interface may be provided via a web interface in various other embodiments.

FIG. 18 is an example of an interface 1800 which may be provided to the contractor by MSPR platform 402 for viewing available leads. Leads interface 1800 may include a listing of leads 1802 which have been made available to the contractor by MSPR platform 402. The available leads 1802 are shown to include information 1804 describing the type of HVAC device for which service is requested (e.g., by device type, by model number, etc.), details 1806 regarding whether any other contractors have submitted bids (e.g., 0 other bidders), the location 1808 of the HVAC equipment (e.g., Milwaukee, 10 miles away, etc.), an estimated cost 1810 for repairing the HVAC equipment (e.g., $500-$700), and a time 1812 that the bid was submitted (e.g., one minute ago, 10:03 AM on Jun. 23, 2015, etc.).

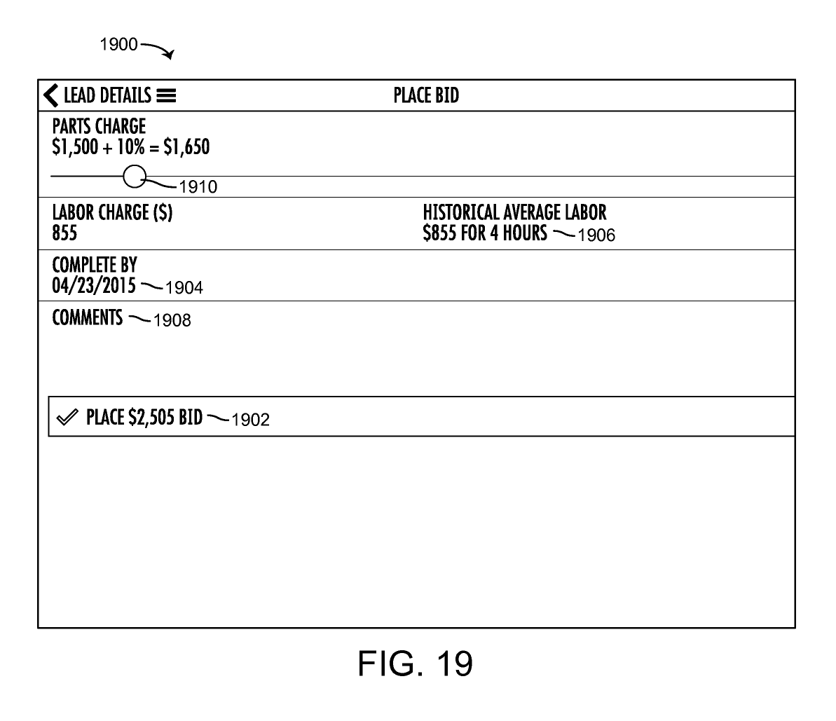

FIG. 19 is an example of an interface 1900 which may be provided to the contractor by MSPR platform 402 for placing bids on available leads. Bid placement interface 1900 may include an estimated cost 1902 of performing the service, which may be estimated by MSPR platform 402 and provided to the contractor. Bid placement interface 1900 may include further details relating to the lead (e.g., a date 1904 by which the service must be completed, a historical cost of labor 1906 for servicing similar problems or HVAC equipment, comments 1908 provided by the building owner, etc.). Bid placement interface 1900 may allow the contractor to adjust estimated cost 1902 (e.g., by sliding a slider 1910 or entering a different bid amount) and to submit the bid to MSPR platform 402.

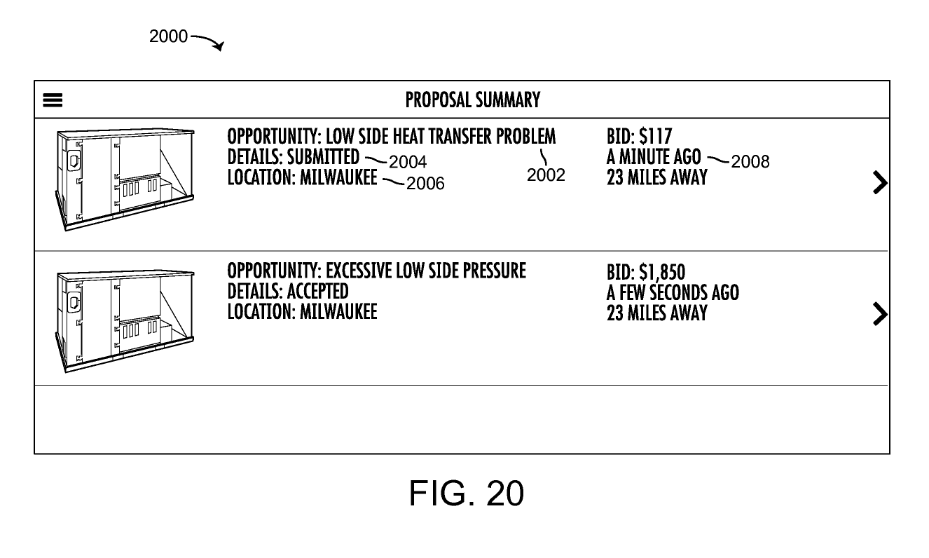

FIG. 20 is an example of an interface 2000 which may be provided to the contractor by MSPR platform 402 for viewing the status of the bids proposed by the contractor. Proposal summary interface 2000 is shown to include information 2002 describing the service opportunity or detected fault with the HVAC equipment (e.g., low side heat transfer problem, excessive low side pressure, etc.), a status 2004 of the bid submission (e.g., whether the bid has been submitted, accepted, rejected, etc.), the location 2006 of the HVAC equipment (e.g., Milwaukee, 10 miles away, etc.), the bid amount (e.g., $1,850), and a time 2008 that the bid was submitted (e.g., one minute ago, 10:03 AM on Jun. 23, 2015, etc.).

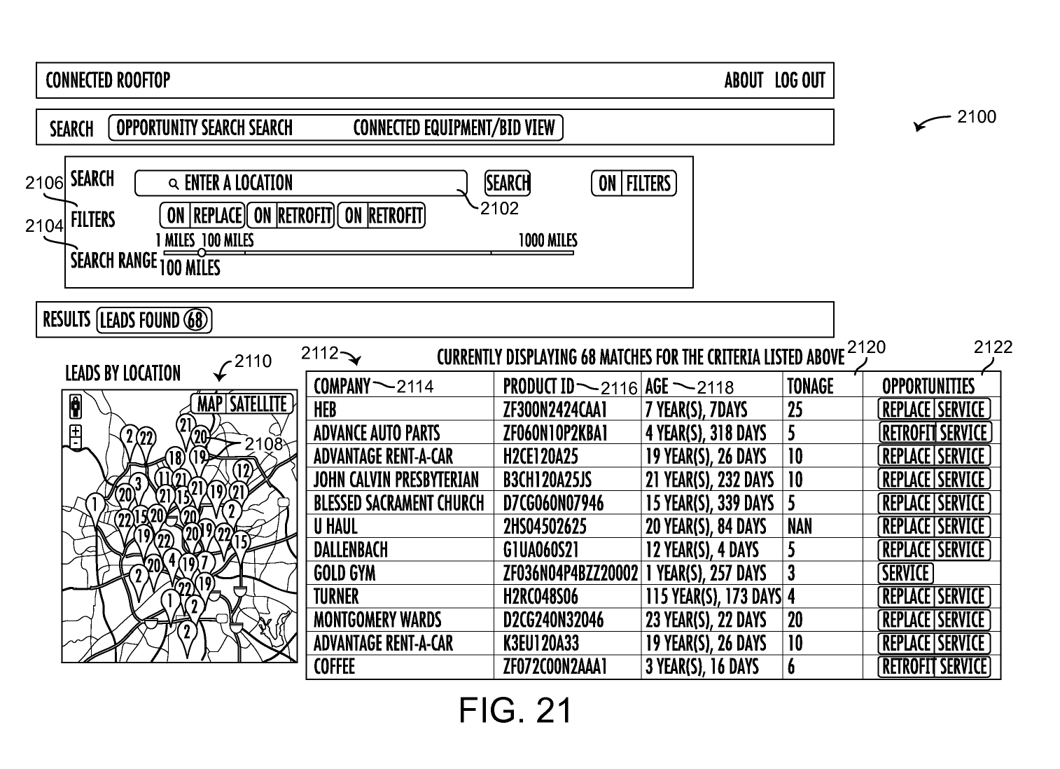

Referring now to FIGS. 21-26 a user interface 2100-2600 which may be provided to a sales representative by MSPR platform 402 is shown, according to an exemplary embodiment. The sales representative may create an account with MSPR platform 402 and specify the location of the sales representative, the expertise of the sales representative, and/or other details related to the sales representative's business. The sales representative can login to his or her account to monitor smart connected HVAC equipment 408 that provides data to MSPR platform 402. Although the sales representative interface is shown as a web interface, the sales representative interface may be provided via an application for a mobile device in various other embodiments.

FIG. 21 is an example of a user interface 2100 which may be provided to the sales representative by MSPR platform 402 for monitoring and viewing service or sales opportunities for smart connected HVAC equipment. Monitoring interface 2100 may allow the sales representative to enter a geographic location in search box 2102 and view all of smart connected HVAC equipment 408 located within a given distance (i.e., search range 2104) of the geographic location. Monitoring interface 2100 may allow the sales representative to adjust the search range 2104 to narrow or expand the search radius.

In some embodiments, monitoring interface 2100 includes filters 2106 that allow the sales representative to filter available opportunities by type (e.g., replacement opportunities, retrofit opportunities, service opportunities, etc.). The available opportunities may be displayed visually as markers 2108 on a map 2110, with each marker indicating (e.g., by color) the type of opportunity. For example, replacement opportunities may be shown as red markers, retrofit opportunities may be shown as yellow markers, and service opportunities may be shown as blue markers on the map. The available opportunities may also be displayed as a list 2112 which includes the name 2114 of the company or building associated with the opportunity, the type 2116 of equipment associated with the opportunity, the age 2118 of the opportunity, the tonnage 2120 of the identified equipment, and the type 2122 of opportunity.

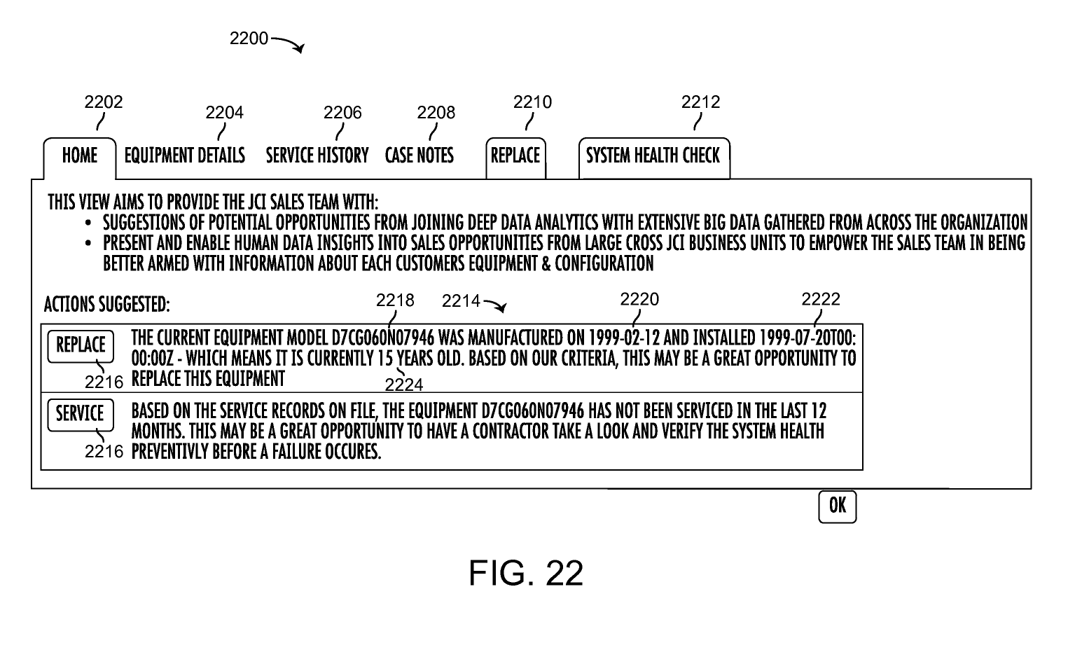

FIG. 22 is an example of a user interface 2200 which may be provided to the sales representative by MSPR platform 402 for viewing summary information associated with a selected opportunity. Summary information interface 2200 may be displayed in response to the sales representative selecting one of the available opportunities in monitoring interface 2100 of FIG. 21. Summary information interface 2200 is shown to include a home tab 2202, an equipment details tab 2204, a service history tab 2206, a case notes tab 2208, a replace tab 2210, and a system health check tab 2212.

Summary information interface 2200 may provide the sales representative with details 2214 regarding the HVAC equipment as well as suggested actions 2216 for repairing, replacing, or retrofitting the HVAC equipment. For example, suggested actions 2216 are shown to include the equipment model code 2218, the date of manufacture 2220, the installation date 2222, and the age 2224 of the equipment. Suggested actions 2216 may indicate whether the HVAC equipment is a good candidate for replacement, repair, and/or retrofitting based on criteria established by MSPR platform 402.

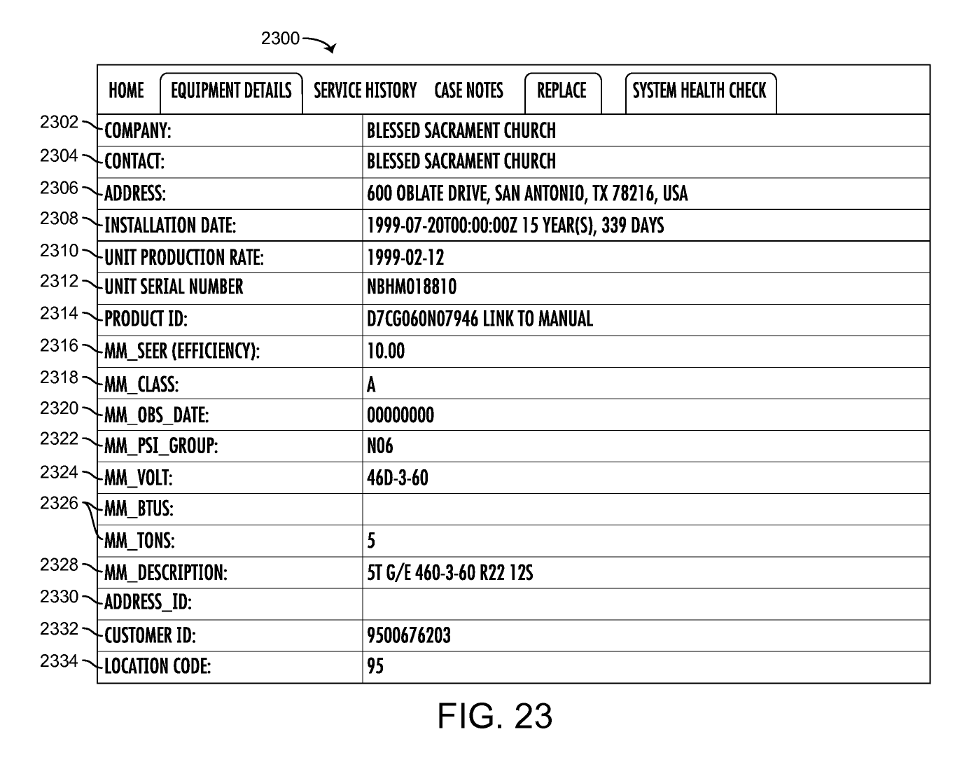

FIG. 23 is an example of a user interface 2300 which may be provided to the sales representative by MSPR platform 402 for viewing details of the identified HVAC equipment. Equipment details interface 2300 may be displayed in response to the sales representative selecting equipment details tab 2204 in interface 2200. The information provided via equipment details interface 2300 may describe the identified HVAC equipment and/or the location at which the HVAC equipment is installed.

Equipment details interface 2300 is shown to include a company name 2302, contact information 2304, an address 2306, an installation date 2308, a unit production date 2310, a unit serial number 2312, a product ID 2314, an efficiency value 2316, a class 2318, an OBS date 2320, a PSI group 2322, volt data 2324, equipment capacity data 2326 (e.g., BTUs or tons), a description 2328 of the HVAC equipment, an address ID 2330, a customer ID 2332, and a location code 2334. In some embodiments, equipment details interface 2300 includes a link 2336 to a product manual. When product manual link 2336 is selected, MSPR platform 402 may retrieve the product manual from storage and provide the product manual to the sales representative.

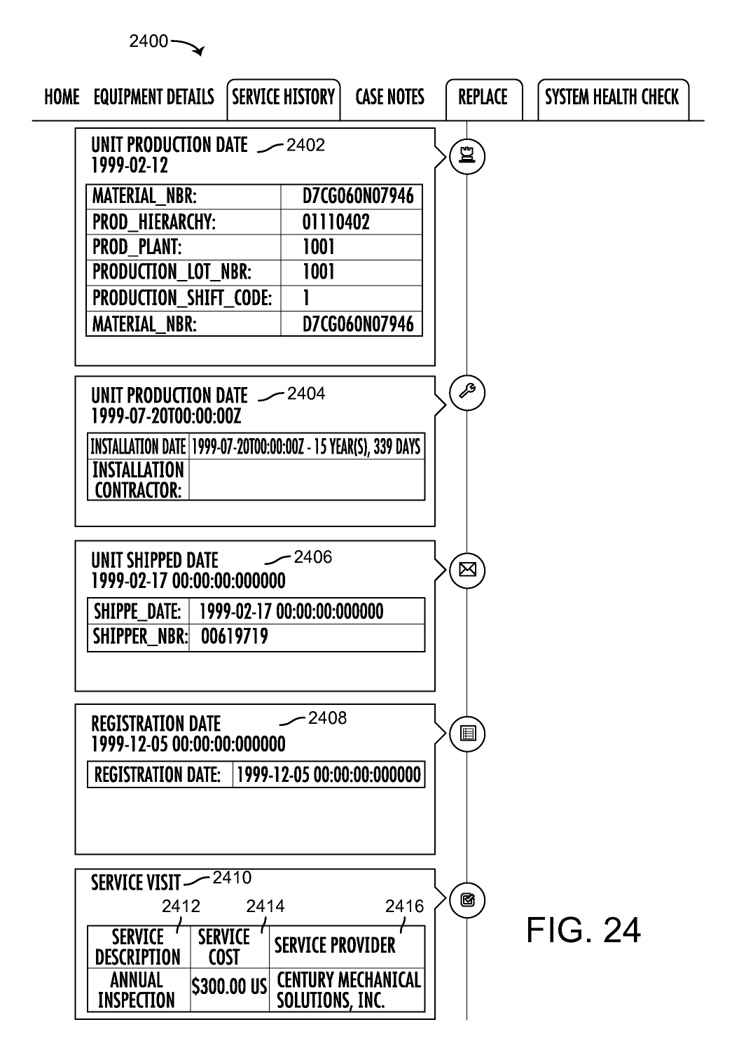

FIG. 24 is an example of a user interface 2400 which may be provided to the sales representative by MSPR platform 402 for viewing a service history for the identified HVAC equipment. Service history interface 2400 may be displayed in response to the sales representative selecting service history tab 2206 in interface 2200. Service history interface 2400 may describe various events that have occurred in the life of the identified HVAC equipment. For example, service history interface 2400 may describe a unit production date 2402, a unit installation date 2404, a unit shipping date 2406, a registration date 2408, and/or various service visits 2410 associated with the HVAC equipment. The service visit information may include a description of the service 2412, the cost of the service 2414, and a service provider 2416 that performed the service.

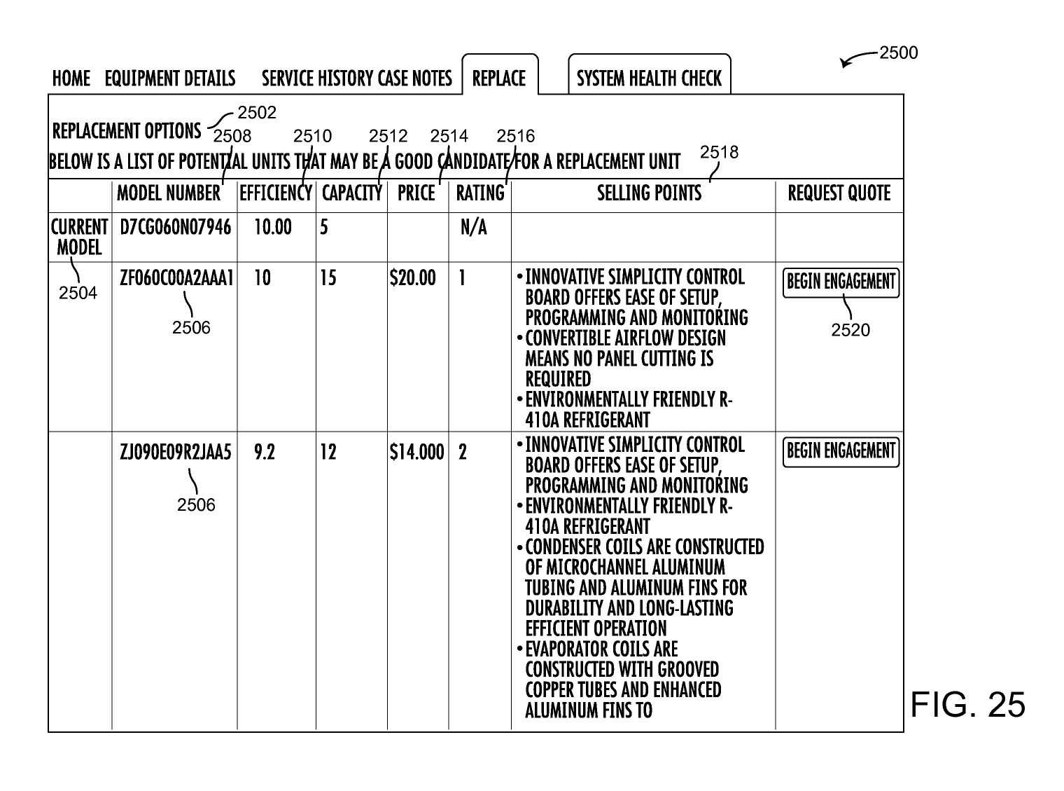

FIG. 25 is an example of a user interface 2500 which may be provided to the sales representative by MSPR platform 402 for viewing replacement opportunities for the identified HVAC equipment. Replacement interface 2500 may be displayed in response to the sales representative selecting replace tab 2210 in interface 2200. Replacement interface 2500 may list one or more replacement options 2502 for the HVAC equipment. Replacement interface 2500 is shown to various types of information describing both the existing HVAC equipment 2504 and potential replacement options 2506. For example, replacement interface 2500 is shown to include a model number 2508, an efficiency 2510, a capacity 2512, a price 2514, a rating or ranking of the available options 2516, and selling points 2518 that the sales representative can use to sell the replacement options to the building owner. Replacement interface 1500 may include a selectable link 2520 which allows the sales representative to request a quote from a manufacturer, a distributor, and/or a contractor for installing the replacement equipment.

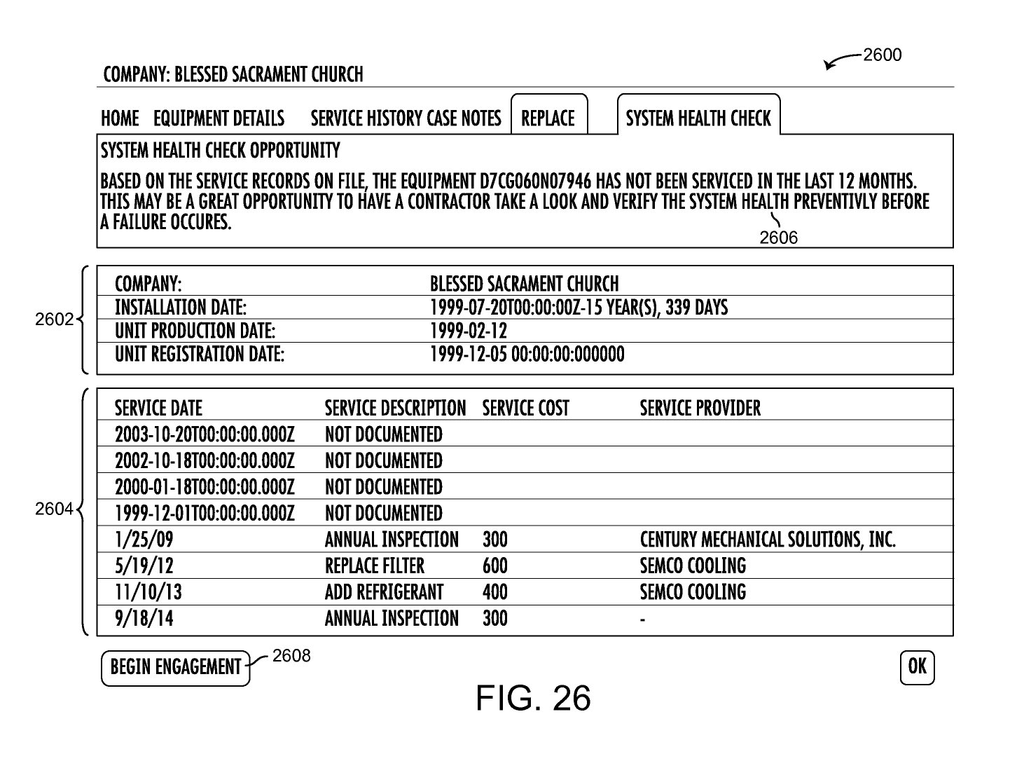

FIG. 26 is an example of a user interface 2600 which may be provided to the sales representative by MSPR platform 402 for viewing the system health of the identified HVAC equipment. System health interface 2600 may be displayed in response to the sales representative selecting system health check tab 2212 in interface 2200. System health interface 2600 may include summary information relating to the identified HVAC equipment 2602 and the service history 2604 of the HVAC equipment. System health interface 2600 may include suggested service actions 2606 that can be performed to address potential problems before they occur. System health interface 2600 may include a selectable link 2608 which allows the sales representative to request a quote from a contractor for servicing the HVAC equipment.

### Subjectivity Modeling in Automated Service Provider Recommendations

Referring now to FIG. 27, a block diagram 2700 illustrating the motivation for subjectivity modeling in automated service provider recommendations is shown, according to an exemplary embodiment. Subjectivity modeling is the process of developing and using a subjectivity model which represents a building owner's subjective preferences when selecting a contractor. For example, a building owner may select a contractor based on a variety of factors such as the contractor's proximity or distance from the building owner, the contractor's consumer rating or reputation score, a number of years the contractor has been in service, the contractor's credit score, the contractor's average time to completion, a number of outstanding claims against the contractor, the contractor's annual revenue, the contractor's average growth rate, the contractor's average labor rate, the contractor's liability, the contractor's insurance, the contractor's number of employees, the contractor's ethnic background, whether the contractor has previously worked with the building owner, and/or other attributes that can be used to describe or characterize various contractors.

The relative importance that a building owner assigns to various contractor attributes can be subjective and may vary among building owners. For example, FIG. 27 shows two building owners: Building Owner A and Building Owner B. Building Owner A has previously selected Contractor A and Contractor B, whereas Building Owner B has previously selected Contractor C, Contractor D, and Contractor E. Even if Building Owner A and Building Owner B have similar buildings, it can be difficult to determine whether Building Owner A would select Contractor E over Contractor A and/or Contractor B. A subjectivity model may capture a building owner's subjective preferences in order to improve the relevance and suitability of the contractor recommendations provided by MSPR platform 402.

Many individuals are unaware of their subjective preferences and/or are unable to rank their preferences in order of importance. Accordingly, it can be difficult and challenging to determine whether a building owner is likely to select one contractor over another contractor, even if the contractor's attributes are known. MSPR platform 402 uses subjectivity modeling to capture a building owner's subjective preferences based on the actual decisions (i.e., contractor selections) made by the building owner. This allows MSPR platform 402 to automatically determine which contractor attributes are most important to a building owner (e.g., as evidenced by the building owner's contractor selections) without requiring the building owner to explicitly rank the importance of each contractor attribute.

In some embodiments, MSPR platform 402 uses attributes of the building owners (i.e., owner attributes) to generate user profiles for the building owners and group the building owners into clusters. Owner attributes may include, for example, the type of building owned by the building owner, the building's location, the building's size, the vertical market of the building owner, the building owner's annual spending on HVAC, and/or other attributes that can be used to describe or characterize the building owners or their buildings. In some embodiments, the contractor selections made any of the building owners in a cluster are attributed to each building owner in the cluster. This allows MSPR platform 402 to use similarities between building owners to apply an existing subjectivity model to a particular building owner, even if the building owner has not made any contractor selections.

MSPR platform 402 may use the contractor selections made by a cluster of building owners to automatically determine which of the contractor attributes are most important to the cluster of building owners. For example, if a cluster of building owners selects multiple contractors having similar values for a particular contractor attribute, MSPR platform 402 may increase a weight assigned to the contractor attribute. Advantageously, this allows MSPR platform 402 to automatically establish a subjectivity model for the cluster of building owners without requiring the building owners to define which of the contractor attributes are most important. Additional features and advantages of MSPR platform 402 with respect to subjectivity modeling are described in detail with reference to FIG. 28.

### Contractor Recommendation System

Referring now to FIG. 28, a block diagram of a contractor recommendation system 2800 is shown, according to an exemplary embodiment. In some embodiments, contractor recommendation system 2800 is a component of MSPR platform 402. For example, contractor recommendation system 2800 may be used in MSPR platform 402 to perform the functions of contractor recommender 1314, as described with reference to FIG. 13. In other embodiments, contractor recommendation system 2800 is a separate system which may be used (alone or in combination with MSPR platform 402) to provide contractor recommendations to building owners 2828. Contractor recommendation system 2800 may interact with HVAC equipment 2826, building owners 2828, contractors 2830, and/or sales representatives 2832 in the same or similar manner as MSPR platform 402, as described with reference to FIGS. 12-13.

Contractor recommendation system 2800 is shown providing building owners 2828 with a set or list of recommended contractors. The recommended contractors may be selected by contractor recommendation system 2800 using subjectivity models trained from previous contractor selections made by building owners 2828. As previously described, the subjectivity models are intended to capture the subjective preferences of building owners 2828 by assigning weights to various contractor attributes. Building owners 2828 may view the list of recommended contractors provided by contractor recommendation system 2800 and select one or more of contractors 2830 from the list. The selected contractor is provided as a feedback to contractor recommendation system 2800 and used by contractor recommendation system 2800 to update the subjectivity models (e.g., by updating the weights assigned to contractor attributes).

Contractor recommendation system 2800 is shown to include a communications interface 2802 and a processing circuit 2804. Communications interface 2802 may include any number and/or type of wired or wireless communications interfaces (e.g., jacks, antennas, transmitters, receivers, transceivers, wire terminals, etc.) for conducting electronic data communications with external systems or devices. Communications via communications interface 2802 may be direct (e.g., local wired or wireless communications) or via a communications network (e.g., a WAN, the Internet, a cellular network, etc.). For example, communications interface 2802 may include an Ethernet card and port for sending and receiving data via an Ethernet-based communications link or network, a WiFi transceiver for communicating via a wireless communications network, a cellular or mobile phone communications transceiver, a power line communications interface, or any other type of wired or wireless communications interface.

Communications interface 2802 may facilitate communications between contractor recommendation system 2800 and various external systems or devices. For example, communications interface 2802 may be used to communicate with HVAC equipment 2826, building owners 2838, contractors 2830, sales reps 2832, building management systems, building controllers, user devices, and/or other connected systems or devices. Communications interface 2802 may be communicably connected to processing circuit 2804 such that processing circuit 2804 and the various components thereof can send and receive data via communications interface 2802.

Processing circuit 2804 is shown to include a processor 2806 and memory 2808. Processor 2806 can be implemented as a general purpose processor, an application specific integrated circuit (ASIC), one or more field programmable gate arrays (FPGAs), a group of processing components, or other suitable electronic processing components. Memory 2808 (e.g., memory, memory unit, storage device, etc.) may include one or more devices (e.g., RAM, ROM, Flash memory, hard disk storage, etc.) for storing data and/or computer code for completing or facilitating the various processes, layers and modules described herein. Memory 2808 may be or include volatile memory or non-volatile memory. Memory 2808 may include database components, object code components, script components, or any other type of information structure. According to an exemplary embodiment, memory 2808 is communicably connected to processor 2806 via processing circuit 2804 and includes computer code for executing (e.g., by processing circuit 2804 and/or processor 2806) one or more processes described herein.

Still referring to FIG. 28, contractor recommendation system 2800 is shown to include a contractor database 2810. Contractor database 2810 may store information relating to various contractors 2830 which can be selected and/or recommended by contractor recommendation system 2800. For example, contractor database 2810 may identify each of contractors 2830 by name (e.g., a contractor name, a business name, etc.) and may indicate the type of service that each contractor is capable of performing. In some embodiments, contractors 2830 include a plurality of contractors that have registered with contractor recommendation system 2800 and/or subscribed to contractor recommendation system 2800.

In some embodiments, contractor database 2810 stores contractor attributes for each of contractors 2830. Contractor attributes may include, for example, a location of the contractor (e.g., the contractor's street address, city, a zip code, etc.), a consumer rating or reputation score, a number of years the contractor has been in service, the contractor's credit score, the contractor's average time to completion, a number of outstanding claims against the contractor, the contractor's annual revenue, the contractor's average growth rate, the contractor's average labor rate, the contractor's liability, the contractor's insurance, the contractor's number of employees, the contractor's ethnic background, a list of building owners with which the contractor has previously worked, and/or other attributes that can be used to describe or characterize contractors 2830.

In some embodiments, contractor database 2810 stores n distinct attributes for each of contractors 2830. Determining which of the attributes are relevant to the contractor recommendations provided by contractor recommendation system 2800 can be considered as a dimension reduction problem in data processing. A dimension reduction can be achieved in a number of ways including, for example, vector quantization, principal component analysis, and auto-associative memory. To enhance the precision of the contractor recommendations, contractor recommendation system 2800 may identify the most discriminate attributes for recognition and the most expressive attributes for clustering (described in greater detail below).

In some embodiments, contractor database 2810 stores an initial recommendation for each of contractors 2830. The initial recommendation may be specified by an expert when a contractor is first added to contractor database 2810 and/or automatically determined based on the similarity of the contractor to other contractors already stored in contractor database 2810. For example, contractors 2830 may be grouped into clusters based on the initial recommendation associated with each contractor (e.g., highly recommended, moderate, not recommended, etc.). In other embodiments, contractors 2830 may be grouped into clusters based on the contractor attributes associated with each of contractors 2830. For example, contractor recommendation system 2800 or a component thereof (e.g., processing circuit 2804) may extract and/or identify contractor attributes for each of contractors 2830 when contractors 2830 are initially added to contractor database 2810. The contractor attributes may be updated or changed if necessary. The contractor attributes may be used to organize contractors 2830 into clusters of similar contractors for purposes of establishing an initial recommendation.

Still referring to FIG. 28, contractor recommendation system 2800 is shown to include a building owner database 2812. Building owner database 2812 may store information relating to various building owners 2828 to which contractor recommendations may be provided by contractor recommendation system 2800. For example, building owner database 2812 may identify each of building owners 2828 by name (e.g., a personal name, a building name, a business name, etc.) and may indicate the type of HVAC equipment 2826 associated with each of building owners 2828 (e.g., owned by building owners 2828, registered to building owners 2828, installed in buildings associated with building owners 2828). In some embodiments, building owners 2828 include a plurality of building owners that have registered with contractor recommendation system 2800 and/or subscribed to contractor recommendation system 2800.

Building owner database 2812 may store a plurality of owner attributes for each of building owners 2828 and/or the buildings or HVAC equipment 2826 associated therewith. Owner attributes may include, for example, demographic information (e.g., occupation, age, education level), type of business, a history of services purchased by building owners 2828, the type of building, building location, building size, vertical market, annual spending on HVAC, and/or other attributes that can be used to describe or characterize building owners 2828, the buildings owned by building owners 2828, and/or the HVAC equipment 2826 installed in such buildings. Owner attributes may be used in conjunction with contractor attributes (e.g., by contractor recommender 2818) to generate a list of recommended contractors for a particular building owner.

Contractor recommendation system 2800 is shown to include an owner profiler/clusterer 2816. Owner profiler/clusterer 2816 may be configured to generate owner profiles for each of building owners 2828. The owner profiles may include any of the owner attributes stored in building owner database 2812. In some embodiments, each owner profile includes a history of contractor selections made by a particular building owner, a cluster to which the building owner has been assigned, and/or other owner-specific information or cluster-specific information that may be used by contractor recommendation system 2800 to determine the building owner's subjective preferences.

In some embodiments, owner profiler/clusterer 2816 groups building owners 2828 into clusters based on the owner attributes and/or owner profiles associated with each of building owners 2828. For example, contractor recommendation system 2800 or a component thereof (e.g., processing circuit 2804) may extract and/or identify owner attributes for each of building owners 2828 when building owners 2828 are initially added to building owner database 2812. The owner attributes may be updated or changed if necessary. Owner profiler/clusterer 2816 may use the owner attributes to organize building owners 2828 into clusters of similar building owners for purposes of generating contractor recommendations suitable for the building owner. For example, the contractor selections made by a particular building owner may be attributed to all of the building owners 2828 assigned to the same cluster as the building owner making the contractor selection. This allows the subjective preferences of one building owner to be used to train a subjectivity model for an entire cluster of building owners 2828. When a new building owner 2828 is added to building owner database 2812, the building owner may be assigned to a cluster and the subjectivity model for the cluster may be used to make contractor recommendations, even if the building owner has not yet provided any feedback (i.e., contractor selections) to contractor recommendation system 2800.

Still referring to FIG. 28, contractor recommendation system 2800 is shown to include an attribute weights database 2814. Attribute weights database 2814 may store weights for various contractor attributes. For example, each of the contractor attributes stored in contractor database 2810 may be assigned a weight (e.g., a numerical score) based on how important that attribute is to a particular building owner or cluster of building owners 2828. In some embodiments, attribute weights database 2814 stores a separate set of attribute weights for each building owner or each cluster of building owners 2828. In other words, each set of attributes may be specific to a particular building owner or cluster of building owners 2828.

In some embodiments, the attribute weights stored in database 2814 are initially specified by building owners 2828 or by an expert. For example, contractor recommendation system 2800 may generate a user interface which can be used by building owners 2828 to specify weights for various contractor attributes. Building owners 2828 can interact with contractor recommendation system 2800 to provide initial attribute weights for each of the contractor attributes. For example, a building owner may specify a weight of 25% for the “revenue” contractor attribute, 50% for the “number of employees” contractor attribute, and 25% for the “reputation” contractor attribute. Weights may be specified using any scale (e.g., percentages, a scale from 0-9, a normalized scale from 0-1, etc.).

In some embodiments, attribute weights are stored in attribute weights database 2814 in a tabular form. For example, the following table illustrates an exemplary data table which may be used to store attribute weights in database 2814:

| Contractor Attribute | Weight |
|---|---|
| Proximity/Distance From Job Location | 8 |
| Previously Worked With Me | 4 |
| Reputation Score | 9 |
| Ethnic Background | 2 |
| Years In Business | 5 |
| Credit Rating | 0 |
| Average Time To Completion | 8 |
| Number Of Outstanding Claims | 6 |
| Revenue | 1 |
| Annual Growth Rate | 0 |
| Average Labor Rate | 0 |
| Liability | 5 |
| Insurance | 5 |
| Number of Employees | 3 |

In other embodiments, attribute weights are stored using other types of data structures such as vectors, lists, delimited text, etc. For example, the following vector W may be used to store attribute weights for each of the n contractor attributes:

W=[w₁,w₂,w₃, . . . ,wₙ]

where each element of the vector (i.e., w₁, w₂, w₃, etc.) represents a weight for a particular contractor attribute and n is the total number of contractor attributes. Each set of attribute weights may be uniquely associated with a particular building owner or cluster of building owners. For example, attribute weights database 2814 may store a first vector of attribute weights W₁ for a first cluster of building owners 2828, a second vector of attribute weights W₂ for a second cluster of building owners 2828, etc.

In some embodiments, contractor database 2810, building owner database 2812, and attribute weights database 2814 are implemented as separate databases. In other embodiments, two or more of databases 2810-2814 may be combined with each other and/or implemented as a single database. For example, contractor database 2810 may be combined with attribute weights database 2814 to provide a combined database that stores both the contractor attributes and the attribute weights. In some embodiments, databases 2810-2814 are implemented as a component of contractor recommendation system 2800 (e.g., within memory 2808). In other embodiments, databases 2810-2814 are implemented as external databases accessible to contractor recommendation system 2800 via communications interface 2802.

Still referring to FIG. 28, contractor recommendation system 2800 is shown to include a contractor recommender 2818. Contractor recommender 2818 is shown receiving the contractor attributes from contractor database 2810, the owner clusters from owner/profiler clusterer 2816, and the attribute weights from attribute weights database 2814. Contractor recommender 2818 may use such inputs to select one or more of contractors 2830 as recommended contractors for a particular building owner. For example, contractor recommender 2818 may identify the owner cluster of the building owner to which a contractor recommendation is to be provided. Contractor recommender 2818 may retrieve, from attribute weights database 2814, the set of attribute weights that corresponds to the identified owner cluster. Contractor recommender 2818 may use the attribute weights to generate a score for each of contractors 2830 with respect to the building owner and may select one or more of the highest-scoring contractors as recommended contractors.

In some embodiments, contractor recommender 2818 generates a score for each of contractors 2830 by determining how well the contractor's attributes match the attributes of the building owner. For example, contractor recommender 2818 may determine an attribute score sᵢⱼ for each of the n contractor attributes (i.e., i=1 . . . n) for each of the m contractors (i.e., j=1 . . . m) with respect to a particular building owner (or cluster of building owners 2828). Attribute score sᵢⱼ indicates how well the ith contractor attribute of the jth contractor matches the preferences or attributes of the building owner. For example, contractor recommender 2818 may assign a relatively high score to the contractor attribute “proximity/distance from job location” if the contractor's location is close to the location of the building owner, whereas contractor recommender 2818 may assign a relatively low score to the contractor attribute “proximity/distance from job location” if the contractor's location is far from the location of the building owner. Contractor recommender 2818 may score each of the n contractor attributes for each of the m contractors with respect to a particular building owner.

Contractor recommender 2818 may calculate an overall contractor score Kⱼ for each of contractors 2830. In some embodiments, the overall contractor score Kⱼ is a weighted sum of the individual attribute scores sᵢⱼ for the jth contractor. For example, contractor recommender 2818 may calculate the overall contractor score Kⱼ using the following equation:

$${K}_{j} = {\sum }_{i = 1}^{n} {w}_{i} {s}_{ij}$$

where wᵢ is the weight associated with the ith contractor attribute and sᵢⱼ is the attribute score of the ith contractor attribute for the jth contractor with respect to a particular building owner. The overall contractor score Kⱼ indicates how well the attributes of the jth contractor match the attributes or preferences of the building owner, weighted by the attributes that are most important to the building owner.

Contractor recommender 2818 may select one or more of the highest-scoring contractors as the recommended contractors for a particular building owner. As shown in FIG. 28, the recommended contractors may be provided to building owners 2828. The building owner may view the recommended contractors and select one or more of the recommended contractors. The selected contractor may be provided as a feedback to contractor recommendation system 2800 (e.g., via communications interface 2802) for use in improving subsequent contractor recommendations. For example, contractor recommendation system 2800 may use the feedback from building owners 2828 (i.e., the contractor selection) to update the weights assigned to various contractor attributes.

Still referring to FIG. 28, contractor recommendation system 2800 is shown to include a distance calculator 2820. Distance calculator 2820 is shown receiving the set of recommended contractors from contractor recommended 2818 and the selected contractor from communications interface 2802. Distance calculator 2820 may be configured to determine a similarity between the selected contractor and each of the recommended contractors. In various embodiments, the similarity may be expressed as a distance (e.g., a cosine distance, a Euclidean distance, a hamming distance, etc.) between the selected contractor and each of the recommended contractors. In some embodiments, distance calculator 2820 determines a similarity between multiple contractors selected by the building owner or cluster of building owners. The similarity may include, for example, a contractor attribute that is the same or similar among the selected contractors (e.g., a low distance or deviation among selected contractors for a particular contractor attribute).

In some embodiments, distance calculator 2820 generates a vector Aⱼ of attributes for each of the recommended contractors and a vector Aₛ of attributes for the selected contractor. Each element of the vector Aⱼ may represent one of the n contractor attributes aᵢⱼ (i=1 . . . n) for the jth recommended contractor, as shown in the following equation:

Aⱼ=[a₁ⱼ,a₂ⱼ,a₃ⱼ, . . . ,aₙⱼ]

where n is the total number of contractor attributes. Similarly, each element of the vector Aₛ may represent one of the n contractor attributes aᵢₛ (i=1 . . . n) for the selected contractor, as shown in the following equation:

Aₛ=[a₁ₛ,a₂ₛ,a₃ₛ, . . . ,aₙₛ]

where attribute values aᵢⱼ and aᵢₛ are calculated as previously described with reference to contractor recommender 2818.

Distance calculator 2820 may use the vectors of attributes to compute a similarity between the selected contractor and each of the recommended contractors. The similarity may be expressed as a distance between the vectors Aⱼ and Aₛ. For example, distance calculator 2820 may calculate the cosine similarity or cosine distance between vectors Aⱼ and Aₛ using the following equation:

$${D}_{j} = cos ( θ ) = \frac{{A}_{j} \cdot {A}_{s}}{\vert \vert {A}_{j} \vert \vert \vert \vert {A}_{s} \vert \vert}$$

where Dⱼ is the distance between the jth recommended contractor and the selected contractor and θ is the angle between vectors Aⱼ and Aₛ. In other embodiments, distance calculator 2820 may use various other similarity measurements such as Euclidean distance (e.g., linear distance between a n-dimensional data point representing the selected contractor attributes and a n-dimensional data point representing the attributes of a recommended contractor), hamming distance, or any other distance or similarity metric.

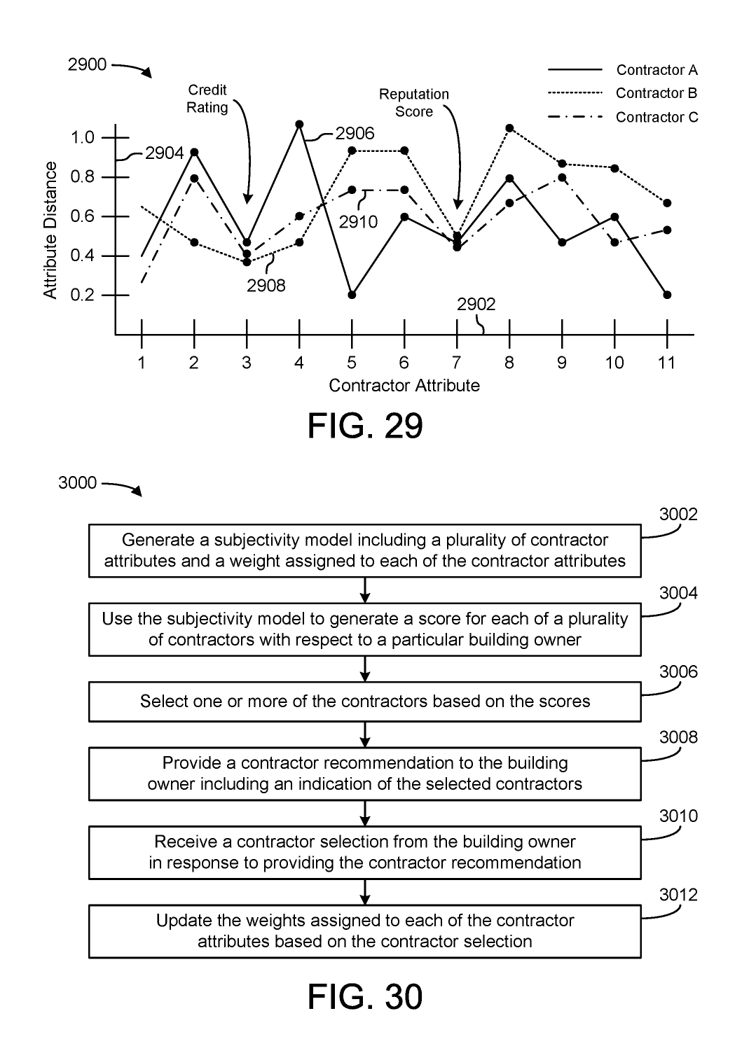

In some embodiments, distance calculator 2820 calculates an attribute-specific distance dᵢⱼ for each of the n contractor attributes (i=1 . . . n) with respect to the attributes of the selected contractor. The attribute-specific distance dᵢⱼ represents the distance between the ith attribute of the selected contractor aᵢₛ and the ith attribute of the jth recommended contractor aᵢⱼ (j=1 . . . m), where m is the total number of recommended contractors. The attribute-specific distance dᵢⱼ may be calculated using any of a variety of distance or similarity metrics (e.g., cosine distance, Euclidean distance, hamming distance, etc.) as previously described. A graph illustrating the attribute-specific distances calculated for several selected contractors is shown in FIG. 29.

In some embodiments, distance calculator 2820 receives multiple selected contractors from communications interface 2802. The selected contractors may be multiple contractors selected by the same building owner or multiple contractors selected by a cluster of building owners (i.e., a set of contractors selected by building owners within the same cluster). Distance calculator 2820 may calculate an attribute-specific distance dᵢₖ for each of the n contractor attributes (i=1 . . . n) and each of the p selected contractors (k=1 . . . p). The attribute-specific distances dᵢₖ may be calculated with respect to a selected contractor attribute aᵢₛ (e.g., an attribute of one of the p selected contractors, an attribute of the most recently-selected contractor, etc.), or a fixed reference value (e.g., a mean or median of the attribute values for a given attribute aᵢₛ) using any of the distance or similarity metrics previously described (e.g., cosine distance, Euclidean distance, hamming distance, etc.).

Still referring to FIG. 28, contractor recommendation system 2800 is shown to include a deviation calculator 2822. Deviation calculator 2822 is shown receiving the attribute distances from distance calculator 2820. The attribute distances may include the attribute-specific distances dᵢⱼ (i.e., the distances between the ith attribute of the selected contractor aᵢₛ and the ith attribute of the jth recommended contractor aᵢⱼ) and/or the attribute-specific distances dᵢₖ (i.e., the distances between corresponding attributes of multiple previously-selected contractors). In some embodiments, deviation calculator 2822 receives the distances Dⱼ (i.e., the distances between the selected contractor and each of the recommended contractors) from distance calculator 2820.

Deviation calculator 2822 may use the attribute distances to calculate an attribute-specific deviation δᵢ among the attribute distances with respect to each of the n contractor attributes (i=1 . . . n). In some embodiments, the deviation δᵢ is the standard deviation of the attribute distances received from distance calculator 2820. For example, deviation calculator 2822 may calculate the deviation δᵢ using the equation:

$${δ}_{i} = \sqrt{\frac{1}{m} {\sum }_{j = 1}^{m} {( {d}_{ij} - {\overline{d}}_{l} )}^{2}}$$

where m is the total number of attribute-specific distances dᵢⱼ for the ith contractor attribute, and d̅ᵢ is the mean of the attribute-specific distances dᵢⱼ. In other embodiments, the deviation δᵢ is calculated using the attribute-specific distances dᵢₖ in place of dᵢⱼ in the previous equation. In further embodiments, the deviation δᵢ is calculated using the attribute values aᵢₛ in place of dᵢⱼ in the previous equation, where aᵢₛ represents the attribute value of one of the selected contractors with respect to the ith contractor attribute.

In general, the deviation δᵢ indicates the amount of variance or spread between the attribute values and/or distances for the ith contractor attribute. Smaller values of δᵢ indicate that the attribute values and/or distances (i.e., similarity measurements) for the ith contractor attribute are grouped closer together, whereas larger values of δᵢ indicate that the attribute values and/or distances for the ith contractor attribute are spread further apart. Accordingly, smaller values of δᵢ may indicate that the ith contractor attribute is relatively important to a particular building owner or cluster of building owners 2828 since the contractors selected by such building owners have little variation with respect to the ith contractor attribute. In other words, smaller values of δᵢ indicate that building owners 2828 have a stronger preference with respect to the ith contractor attribute and repeatedly select contractors having similar values for the ith contractor attribute. Conversely, larger values of δᵢ may indicate that the ith contractor attribute is relatively unimportant to a particular building owner or cluster of building owners 2828 since the contractors selected by such building owners have a large variation with respect to the ith contractor attribute. In other words, larger values of δᵢ indicate that building owners 2828 have a weak preference with respect to the ith contractor attribute and are willing to select contractors that vary significantly with respect to the ith contractor attribute.

Still referring to FIG. 28, contractor recommendation system 2800 is shown to include a weight updater 2824. Weight updater 2824 is shown receiving the distance deviations δᵢ from deviation calculator 2822. Weight updater 2824 may use the distance deviations δᵢ to calculate updated weights wᵢ for each of the n contractor attributes. In some embodiments, weight updater 2824 calculates updated weights using the following equation:

wᵢ=f(δᵢ)=1−δᵢ

where wᵢ is the updated weight for the ith contractor attribute and δᵢ is the deviation calculated for the ith contractor attribute. The previous equation for wᵢ results in weight updater 2824 calculating a relatively greater weight for contractor attributes with a smaller deviation δᵢ, and a relatively lesser weight for contractor attributes with a greater deviation δᵢ. Weight updater 2824 may calculate updated weights wᵢ for each of the i contractor attributes and store the updated weights in attribute weights database 2814.

In some embodiments, weight updater 2824 stores the updated weights in a weight vector Wₜⁱ. The weight vector Wₜⁱ may be a m-dimensional vector having elements that indicate the weight wᵢ assigned to contractor attribute i at time t according to m different similarity measurements. Weight updater 2824 may retain a history of previous weight vectors [W₀ⁱ, W₁ⁱ, W₂ⁱ, . . . , Wₜ₋₁ⁱ] and use the history of previous weight vectors to calculate a new weight vector W′ₜⁱ at time t according to the following equation:

$${W}_{t}^{′ i} = \frac{{\sum }_{j = 1}^{j = t - 1} {W}_{j}^{i} K ( D ( {W}_{j}^{i} , {W}_{t}^{i} ) )}{{\sum }_{j = 1}^{j = t - 1} K ( D ( {W}_{j}^{i} , {W}_{t}^{i} ) )}$$

where K is a weighting function or kernel function used to calculate a weight for a data point from the distance (e.g., K(D)=e^{-d}^{²}). The expression D(Wⱼⁱ, Wₜⁱ) may be defined as follows:

D(Wⱼⁱ,Wₜⁱ)=\sqrt{(Wₜ−Wⱼ)^{T}(Wⱼ,wₜ)}

In some embodiments, weight updater 2824 uses principal component analysis (PCA) to update the contractor attribute weights. For example, weight updater 2824 may use PCA to find the relative importance of each contractor attribute rather than finding the most biased attribute. Another benefit of PCA is the ability to provide quantitative analysis of discrimination power of each component. For example, weight updater 2824 may represent the dissimilarity measurement obtained from PCA in the form of a linear equation as follows:

D_{q,j}=Σᵢ₌₀ⁱ⁼ⁿaᵢfᵢ

where aᵢ indicates the ith weighting factor and fᵢ represents the return value from the ith distance measurement function based on the corresponding contractor attribute. D_{q,j} represents the distance between the query object q (e.g., a selected contractor attribute) and the target object j (e.g., a contractor attribute of a recommended contractor), whereas aᵢ represents the relative importance of the similarity measurement. In other words, if a certain contractor attribute has more discrimination power than others, it will provide a larger contribution to the similarity measurement compared to the other contractor attributes. The PCA approach therefore results in a dissimilarity metric based on the contractor attribute and eliminates the trial-and-error process typically used to find a proper combination of weight values in attribute-based recommendation.

Referring now to FIG. 29, a graph 2900 illustrating attribute-specific distances for several contractor attributes is shown, according to an exemplary embodiment. Graph 2900 is shown to include an x-axis 2902 indicating various contractor attributes and a y-axis 2904 indicating attribute distance. Contractor attributes may include, for example, a location of the contractor (e.g., the contractor's street address, city, a zip code, etc.), a consumer rating or reputation score, a number of years the contractor has been in service, the contractor's credit score, the contractor's average time to completion, a number of outstanding claims against the contractor, the contractor's annual revenue, the contractor's average growth rate, the contractor's average labor rate, the contractor's liability, the contractor's insurance, the contractor's number of employees, the contractor's ethnic background, a list of building owners with which the contractor has previously worked, and/or other attributes that can be used to describe or characterize contractors 2830. Graph 2900 includes 11 contractor attributes spaced horizontally along axis 2902.

The attribute distances may include any of the attribute-specific distances calculated by distance calculator 2820, as described with reference to FIG. 28. For example, attribute distances may include the attribute-specific distances dᵢⱼ (i.e., the distances between the ith attribute of the selected contractor aᵢₛ and the ith attribute of the jth recommended contractor aᵢⱼ) and/or the attribute-specific distances dᵢₖ (i.e., the distances between corresponding attributes of multiple previously-selected contractors). The vertical position of each data point in graph 2900 indicates the value of the attribute distance for the corresponding contractor attribute.

The lines 2906-2910 connecting the data points in graph 2900 represent different contractors. For example, line 2906 represents contractor A, line 2908 represents contractor B, and line 2910 represents contractor C. The data points connected by each of lines 2906-2910 correspond to the attribute distances calculated for a particular contractor (e.g., a contractor selected by building owners 2828). For contractor attributes 1-2, 4-6, and 8-11, the attribute distances for each of contractors A-C are significantly different, as is indicated by a greater spread or deviation of the attribute distances for such contractor attributes. However, the attribute distances for contractor attribute 3 (i.e., credit rating) and contractor attribute 7 (i.e., reputation score) are more similar, as is indicated by a lesser spread or deviation in the attribute distances for contractor attributes 3 and 7. Accordingly, the deviations δᵢ calculated for contractor attributes 3 and 7 may be significantly lower than the deviations δᵢ calculated for the other contractor attributes. This indicates that building owners 2828 have a stronger preference with respect to contractor attributes 3 and 7, and a weaker preference with respect to the other contractor attributes.

### Subjectivity Modeling Process

Referring now to FIG. 30, a flowchart of a process 3000 for using subjectivity modeling to provide contractor recommendations is shown, according to an exemplary embodiment. Process 3000 may be performed by one or more components of contractor recommendation system 2800, as described with reference to FIG. 28. Process 3000 is shown to include generating a subjectivity model (step 3002). The subjectivity model may include a plurality of contractor attributes and a weight assigned to each of the contractor attributes. In some embodiments, the contractor attributes are stored in a contractor database (e.g., contractor database 2810) and the attribute weights are stored in an attribute weights database (e.g., attribute weights database 2814). In some embodiments, the attribute weights are specific to a particular building owner or cluster of building owners.

Process 3000 is shown to include using the subjectivity model to generate a score for each of a plurality of contractors with respect to a particular building owner (step 3004). In some embodiments, step 3004 includes determining an attribute score sᵢⱼ for each of the n contractor attributes (i=1 . . . n) and each of the m contractors (j=1 . . . m). The attribute score sᵢⱼ may indicate how well the corresponding contractor attribute matches an attribute of the building owner. The attribute score sᵢⱼ may be determined by comparing the attributes of each of the plurality of contractors with attributes of the building owner. For example, an attribute score for the “contractor location” attribute may be generated by comparing the location of the contractor with the location of the building owner. The attribute score sᵢⱼ for the contractor location attribute may be assigned a relatively high score if the contractor location is close to the location of the building owner, or a relatively low score if the contractor location is far from the location of the building owner.

In some embodiments, step 3004 includes calculating an overall score Kⱼ for each of the plurality of contractors. In some embodiments, the overall contractor score Kⱼ is a weighted sum of the individual attribute scores sᵢⱼ for the jth contractor. For example, step 3004 may include calculating the overall contractor score Kⱼ using the following equation:

$${K}_{j} = {\sum }_{i = 1}^{n} {w}_{i} {s}_{ij}$$

where wᵢ is the weight associated with the ith contractor attribute and sᵢⱼ is the attribute score of the ith contractor attribute for the jth contractor with respect to a particular building owner. The overall contractor score Kⱼ indicates how well the attributes of the jth contractor match the attributes or preferences of the building owner, weighted by the attributes that are most important to the building owner.

Process 3000 is shown to include selecting one or more of the contractors based on the scores (step 3006) and providing a contractor recommendation to the building owner (step 3008). Step 3006 may include selecting a predetermined number of the contractors having the highest overall scores Kⱼ. Step 3008 may include generating a message for the building owner (e.g., an email, a webpage, etc.) and providing the message to the building owner. The message may include the contractor recommendation and may identify one or more recommended contractors for the building owner (i.e., the contractors selected in step 3006). The building owner may receive the contractor recommendation and select one or more of the recommended contractors. Contractor recommendation system 2800 may receive a contractor selection from the building owner in response to providing the contractor recommendation (step 3010).

Process 3000 is shown to include updating the weights assigned to each of the contractor attributes based on the contractor selection (step 3012). Step 3012 may include calculating a distance between the selected contractor and each of the recommended contractors. The distance may be a measure of similarity such as a cosine distance, a Euclidean distance, a hamming distance, etc. between the selected contractor and each of the recommended contractors. In some embodiments, step 3012 includes determining a similarity between multiple contractors selected by the building owner or cluster of building owners. The similarity may include, for example, a contractor attribute that is the same or similar among the selected contractors (e.g., a low distance or deviation among selected contractors for a particular contractor attribute).

In some embodiments, step 3012 includes generating a vector Aⱼ of attributes for each of the recommended contractors and a vector Aₛ of attributes for the selected contractor. Each element of the vector Aⱼ may represent one of the n contractor attributes aᵢⱼ (i=1 . . . n) for the jth recommended contractor, as shown in the following equation:

Aⱼ=[a₁ⱼ,a₂ⱼ,a₃ⱼ, . . . ,aₙⱼ]

where n is the total number of contractor attributes. Similarly, each element of the vector Aₛ may represent one of the n contractor attributes aᵢₛ (i=1 . . . n) for the selected contractor, as shown in the following equation:

Aₛ=[a₁ₛ,a₂ₛ,a₃ₛ, . . . ,aₙₛ]

where attribute values aᵢⱼ and aᵢₛ are calculated as previously described with reference to contractor recommender 2818.

Step 3012 may include using the vectors of attributes to compute a similarity between the selected contractor and each of the recommended contractors. The similarity may be expressed as a distance between the vectors Aⱼ and Aₛ. For example, step 3012 may include calculating the cosine similarity or cosine distance between vectors Aⱼ and Aₛ using the following equation:

$${D}_{j} = cos ( θ ) = \frac{{A}_{j} \cdot {A}_{s}}{\vert \vert {A}_{j} \vert \vert \vert \vert {A}_{s} \vert \vert}$$

where Dⱼ is the distance between the jth recommended contractor and the selected contractor and θ is the angle between vectors Aⱼ and Aₛ. In other embodiments, step 3012 may include using various other similarity measurements such as Euclidean distance (e.g., linear distance between a n-dimensional data point representing the selected contractor attributes and a n-dimensional data point representing the attributes of a recommended contractor), hamming distance, or any other distance or similarity metric.

In some embodiments, step 3012 includes calculating an attribute-specific distance dᵢⱼ for each of the n contractor attributes (i=1 . . . n) with respect to the attributes of the selected contractor. The attribute-specific distance dᵢⱼ represents the distance between the ith attribute of the selected contractor aᵢₛ and the ith attribute of the jth recommended contractor aᵢⱼ (j=1 . . . m), where m is the total number of recommended contractors. The attribute-specific distance dᵢⱼ may be calculated using any of a variety of distance or similarity metrics (e.g., cosine distance, Euclidean distance, hamming distance, etc.) as previously described.

In some embodiments, step 3010 includes receiving multiple selected contractors from the building owner or cluster of building owners. Step 3012 may include calculating an attribute-specific distance dᵢₖ for each of the n contractor attributes (i=1 . . . n) and each of the p selected contractors (k=1 . . . p). The attribute-specific distances dᵢₖ may be calculated with respect to a selected contractor attribute aᵢₛ (e.g., an attribute of one of the p selected contractors, an attribute of the most recently-selected contractor, etc.), or a fixed reference value (e.g., a mean or median of the attribute values for a given attribute aᵢₛ) using any of the distance or similarity metrics previously described (e.g., cosine distance, Euclidean distance, hamming distance, etc.).

Step 3012 may include using the attribute distances to calculate an attribute-specific deviation δᵢ among the attribute distances with respect to each of the n contractor attributes (i=1 . . . n). In some embodiments, the deviation δᵢ is the standard deviation of the calculated attribute distances. For example, step 3012 may include calculating the deviation δᵢ using the equation:

$${δ}_{i} = \sqrt{\frac{1}{m} {\sum }_{j = 1}^{m} {( {d}_{ij} - {\overline{d}}_{l} )}^{2}}$$

where m is the total number of attribute-specific distances dᵢⱼ for the ith contractor attribute, and d̅ᵢ is the mean of the attribute-specific distances dᵢⱼ. In other embodiments, the deviation δᵢ is calculated using the attribute-specific distances dᵢₖ in place of dᵢⱼ in the previous equation. In further embodiments, the deviation δᵢ is calculated using the attribute values aᵢₛ in place of dᵢⱼ in the previous equation, where aᵢₛ represents the attribute value of one of the selected contractors with respect to the ith contractor attribute.

In general, the deviation δᵢ indicates the amount of variance or spread between the attribute values and/or distances for the ith contractor attribute. Smaller values of δᵢ indicate that the attribute values and/or distances (i.e., similarity measurements) for the ith contractor attribute are grouped closer together, whereas larger values of δᵢ indicate that the attribute values and/or distances for the ith contractor attribute are spread further apart. Accordingly, smaller values of δᵢ may indicate that the ith contractor attribute is relatively important to a particular building owner or cluster of building owners 2828 since the contractors selected by such building owners have little variation with respect to the ith contractor attribute. In other words, smaller values of δᵢ indicate that building owners 2828 have a stronger preference with respect to the ith contractor attribute and repeatedly select contractors having similar values for the ith contractor attribute. Conversely, larger values of δᵢ may indicate that the ith contractor attribute is relatively unimportant to a particular building owner or cluster of building owners 2828 since the contractors selected by such building owners have a large variation with respect to the ith contractor attribute. In other words, larger values of δᵢ indicate that building owners 2828 have a weak preference with respect to the ith contractor attribute and are willing to select contractors that vary significantly with respect to the ith contractor attribute.

Step 3012 may include using the distance deviations δᵢ to calculate updated weights wᵢ for each of the n contractor attributes. In some embodiments, the updated weights are calculated using the following equation:

wᵢ=f(δᵢ)=1−δᵢ

where wᵢ is the updated weight for the ith contractor attribute and δᵢ is the deviation calculated for the ith contractor attribute. This equation for wᵢ causes a relatively greater weight to be calculated for contractor attributes with a smaller deviation δᵢ, and a relatively lesser weight to be calculated for contractor attributes with a greater deviation δᵢ. Step 3012 may include calculating updated weights wᵢ for each of the i contractor attributes and storing the updated weights in attribute weights database 2814. The updated weights may then be used in the subjectivity model to generate and provide subsequent contractor recommendations.

Advantageously, the systems and methods described herein use subjectivity modeling to capture a building owner's subjective preferences based on the actual decisions (i.e., contractor selections) made by the building owner. This allows the systems and methods of the present invention to automatically determine which contractor attributes are most important to a building owner (e.g., as evidenced by the building owner's contractor selections) without requiring the building owner to explicitly rank the importance of each contractor attribute.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A contractor recommendation system comprising:
one or more databases storing contractor attributes for a plurality of contractors and attribute weights indicating a relative importance of each of the contractor attributes;
a contractor recommender that uses the contractor attributes and the attribute weights to select one or more recommended contractors for a building owner and generates a contractor recommendation comprising an indication of the one or more recommended contractors;
a communications interface that provides the contractor recommendation to the building owner and receives a contractor selection from the building owner; and
a weight updater that uses the contractor selection as a feedback to determine an importance of each of the contractor attributes to the building owner and automatically updates the stored attribute weights based on the determined importance.

2. The contractor recommendation system of claim 1, wherein:
the one or more databases store building owner attributes for a plurality of building owners; and
the contractor recommender uses the building owner attributes in conjunction with the contractor attributes and the attribute weights to generate the contractor recommendation.

3. The contractor recommendation system of claim 2, further comprising an owner profiler/clusterer that uses the building owner attributes to generate a profile for each of the plurality of building owners and group the building owners into clusters of similar building owners.

4. The contractor recommendation system of claim 1, wherein the one or more databases store a separate set of attribute weights for each building owner or cluster of building owners, each set of attribute weights indicating a relative importance of each of the contractor attributes to a specific building owner or cluster of building owners.

5. The contractor recommendation system of claim 1, further comprising a distance calculator that determines a distance between a contractor selected by the building owner and each of the recommended contractors, wherein the distance is a similarity metric based on the contractor attributes of the selected and recommended contractors.

6. The contractor recommendation system of claim 5, wherein the distance calculator determines, for each of the contractor attributes, an attribute-specific distance between the selected contractor and each of the recommended contractors, wherein each attribute-specific distance is a similarity metric for a particular contractor attribute.

7. The contractor recommendation system of claim 5, wherein the distance calculator:
receives an indication of multiple contractors selected by the building owner or cluster of building owners; and
determines, for each of the contractor attributes, an attribute-specific distance between values of the contractor attribute for each of the selected contractors.

8. The contractor recommendation system of claim 1, further comprising a deviation calculator that uses the contractor selection to calculate an attribute-specific deviation for each of the contractor attributes, the deviation indicating which of the contractor attributes are most important to the building owner.

9. The contractor recommendation system of claim 8, wherein the deviation calculator:
receives an indication of multiple contractors selected by the building owner or cluster of building owners;
identifies, for each of the contractor attributes, a value of the contractor attribute for each of the selected contractors; and
calculates, for each of the contractor attributes, the attribute-specific deviation among the identified values of the contractor attribute.

10. The contractor recommendation system of claim 8, wherein the weight updater uses the attribute-specific deviations for each of the contractor attributes to determine the importance of each of the contractor attributes to the building owner.

11. A monitoring and service provider recommendation (MSPR) platform comprising:
a contractor recommender that automatically selects one or more recommended contractors for a building owner;
a lead generator that generates leads for each of the recommended contractors, the leads indicating an opportunity to service building equipment associated with the building owner;
a bid selector that solicits bids for servicing the building equipment from the recommended contractors and provides the bids to the building owner, wherein the building owner selects a recommended contractor in response to receiving the bids; and
a winning contractor notifier that notifies the selected contractor of winning the bid and provides the selected contractor with customer information relating to the building owner or the building equipment associated with the building owner.

12. The MSPR platform of claim 11, further comprising:
a fault detector that receives data from the building equipment and detects a fault in the building equipment based on the data received from the building equipment; and
an alert generator that generates an alert for the building owner in response to detecting the fault.

13. The MSPR platform of claim 12, further comprising an interface generator that generates a user interface for the building owner to interact with the MSPR platform, the user interface comprising an indication of the detected fault and an interface option for allowing the building owner to request a quote for servicing the building equipment.

14. The MSPR platform of claim 13, wherein the contractor recommender selects the recommended contractors for the building owner in response to receiving a request for a quote from the building owner via the user interface.

15. A method for providing contractor recommendations to a building owner, the method comprising:
storing, in one or more databases, contractor attributes for a plurality of contractors and attribute weights indicating a relative importance of each of the contractor attributes;
using the contractor attributes and the attribute weights to automatically select, by a processing circuit of a contractor recommendation system, one or more recommended contractors for a building owner;
generating, by the processing circuit, a contractor recommendation comprising an indication of the one or more recommended contractors;
providing the contractor recommendation to the building owner and receiving a contractor selection from the building owner via a communications interface of the contractor recommendation system;
using the contractor selection as a feedback to determine, by the processing circuit, an importance of each of the contractor attributes to the building owner; and
automatically updating, by the processing circuit, the stored attribute weights based on the determined importance.

16. The method of claim 15, wherein the one or more databases store a separate set of attribute weights for each building owner or cluster of building owners, each set of attribute weights indicating a relative importance of each of the contractor attributes to a specific building owner or cluster of building owners.

17. The method of claim 15, further comprising determining a distance between a contractor selected by the building owner and each of the recommended contractors, wherein the distance is a similarity metric based on the contractor attributes of the selected and recommended contractors.

18. The method of claim 15, further comprising using the contractor selection to calculate an attribute-specific deviation for each of the contractor attributes, the deviation indicating which of the contractor attributes are most important to the building owner.

19. The method of claim 18, wherein calculating the attribute-specific deviation comprises:
receiving an indication of multiple contractors selected by the building owner or cluster of building owners;
identifying, for each of the contractor attributes, a value of the contractor attribute for each of the selected contractors; and
calculating, for each of the contractor attributes, the attribute-specific deviation among the identified values of the contractor attribute.

20. The method of claim 18, further comprising using the attribute-specific deviations for each of the contractor attributes to determine the importance of each of the contractor attributes to the building owner.
